(19) United States
(12) Patent Application Publication
(10) Pub. No.: US 2025/0019629 A1
(43) Pub. Date: Jan. 16, 2025

(54) GIN REPLICAS

(71) Applicant: Ava Food Labs, Inc., San Francisco, CA (US)

(72) Inventors: Lucas Baker, San Francisco, CA (US); Samantha Shen Magrath, Washington, DC (US); Mardonn Carl Chua, Ann Arbor, MI (US); Lindsay Loretta Smith, San Francisco, CA (US)

(21) Appl. No.: 18/708,883

(22) PCT Filed: Nov. 9, 2022
(86) PCT No.: PCT/US2022/049394

§ 371 Date: May 9, 2024

Related U.S. Application Data
(60) Provisional application No. 63/277,230, filed on Nov. 9, 2021.

(51) Int. Cl. C12G 3/06

(52) U.S. Cl. CPC C12G 3/06

(57) ABSTRACT

Materials and methods for producing gin-like alcoholic beverages containing individual volatile components are provided herein.

### CROSS-REFERENCE TO RELATED APPLICATIONS

This application claims priority from U.S. Provisional Application Ser. No. 63/277,230, filed Nov. 9, 2021. The disclosure of the prior application is considered part of (and is incorporated by reference in) the disclosure of this application.

### TECHNICAL FIELD

This document relates to materials and methods for producing gin-like alcoholic beverages that contain individually added volatile components.

### BACKGROUND

The term “gin” generally refers to a distilled alcoholic drink that predominantly derives its flavor from juniper berries. Gin can be made by several different distillation and flavoring techniques. For example, gin can be produced by pot distilling a fermented mash (e.g., from barley or other grains) and then redistilling it with flavoring botanicals to extract aromatic compounds, followed by aging the gin in tanks or wooden casks. Gin also can be produced by column or reflux distilling, which involves first distilling high proof neutral spirits from a fermented mash or wash using, for example, a column still. The fermentable base for gin can be derived any of a variety of agricultural materials, including grain, sugar beets, grapes, and potatoes. The concentrated spirit is then redistilled with juniper berries and other botanicals in a pot still. In some cases, gin also can be made by infusing neutral spirits with essences, natural flavorings, or natural botanical ingredients, without redistillation.

Besides juniper, which is required for gin, commonly used botanical or flavoring agents include citrus (e.g., lemon and orange), as well as spices such as anise, angelica root, orris root, licorice root, cinnamon, almond, cubeb, savory, lime, grapefruit, dragon eye, saffron, baobab, frankincense, coriander, grains of paradise, nutmeg, cassia bark, and others. Depending on the combination and concentration of botanicals in the distillation process, different gin products vary from each other in taste.

Gin typically is 35 to 60 percent alcohol by volume (ABV), although the alcohol content can vary depending on the type of gin. Traditional methods for producing gin can be lengthy and costly, including the harvesting of particular crops, followed by processing, fermenting, distilling, and aging. Each component of the traditional processes for making gin can have an inherent variability and risk, including climate, crop disease, and contamination, which can render such methods and their resulting products inconsistent from batch to batch and year to year.

### SUMMARY

This document is based, at least in part, on the identification of compounds that contribute to the flavor and aroma of gin, and on the development of methods for combining those compounds to yield gin replicas that have the taste, aroma, and other characteristics of traditionally generated gins. Because each ingredient is added individually, the methods disclosed herein reduce many of the risks and variability associated with traditional gin production. The methods also can provide nearly infinite reproducibility of a recipe, which is not possible with traditional production methods. Further, the methods described herein allow for unique flexibility in optimization of the flavors, aromas, and textures of gins of various types, and can greatly reduce or even eliminate the possibility that the resulting beverage will contain detrimental or undesired components. Moreover, the methods disclosed herein differ from currently existing methods in that they are rapid, reproducible, and cost-effective.

In a first aspect, this document features a gin replica. The gin replica can contain, consist essentially of, or consist of water; a grain neutral spirit; glycerin; optionally, a sugar; optionally, a plant oil, fruit oil, plant flavor, or fruit flavor; and at least three added volatile organic compounds (VOCs), wherein the added VOCs include one or more terpenes and one or more esters, and wherein the added VOCs comprise about 0.001 wt % to about 0.1 wt % of the alcoholic beverage. The one or more terpenes can include one or more of alpha-pinene, d-camphor, d-limonene, eucalyptol, gamma-terpinene, beta-humulene, L-bornyl acetate, linalool, p-cymene, beta-pinene, and terpinolene. The one or more terpenes can include one or more of gamma-terpinene, beta-humulene, linalool, p-cymene, and beta-pinene. The one or more terpenes can include one or more of alpha-pinene, d-camphor, d-limonene, eucalyptol, gamma-terpinene, linalool, p-cymene, beta-pinene, and terpinolene. The one or more terpenes can include one or more of alpha-pinene, d-camphor, eucalyptol, gamma-terpinene, beta-humulene, L-bornyl acetate, linalool, p-cymene, and beta-pinene. The one or more terpenes can include one or more of d-limonene, gamma-terpinene, linalool, and p-cymene. The one or more esters can include one or more of hexyl acetate, ethyl hexanoate, and isobutyl angelate. The one or more esters can include ethyl hexanoate. The added VOCs can further include one or more aldehydes. The one or more aldehydes can include nonanal. The added VOCs can include three or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene. The added VOCs can include five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene. The added VOCs can include ethyl hexanoate, gamma-terpinene, beta-humulene, linalool, p-cymene, and beta-pinene. The added VOCs can include ethyl hexanoate, nonanal, alpha-pinene, d-camphor, d-Limonene, eucalyptol, gamma-terpinene, linalool, p-cymene, beta-pinene, and terpinolene. The added VOCs can include ethyl hexanoate, nonanal, alpha-pinene, d-camphor, eucalyptol, gamma-terpinene, beta-humulene, L-bornyl acetate, linalool, p-cymene, and beta-pinene. The added VOCs can include hexyl acetate, ethyl hexanoate, isobutyl angelate, nonanal, d-limonene, gamma-terpinene, linalool, and p-cymene. The gin replica can further include a sugar selected from the group consisting of sucrose, fructose, and glucose. The gin replica can further include a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil. The gin replica can contain from about 5 wt % to about 70 wt % water; from about 30 wt % to about 95 wt % grain neutral spirits; from about 0.1 wt % to about 5 wt % glycerin; and from about 0.001 wt % to about 1 wt % added VOCs, wherein the added VOCs include five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

The added VOCs can include beta-pinene, wherein the beta-pinene is present in the gin replica at a concentration less than about 0.018 mg/L. The added VOCs can include terpinolene, wherein the terpinolene is present in the gin replica at a concentration less than about 0.018 mg/L. The added VOCs can include d-limonene, wherein the d-limonene is present in the gin replica at a concentration less than about 0.01 mg/L. The added VOCs can include gamma-terpinene, wherein the gamma-terpinene is present in the gin replica at a concentration less than about 0.0056 mg/L. The added VOCs can include linalool, wherein the linalool is present in the gin replica at a concentration less than about 0.5 mg/L. The added VOCs can include d-camphor, and wherein at least about 0.2 wt % of the added VOCs is d-camphor. The added VOCs can include nonanal, wherein at least about 0.03 wt % of the added VOCs is nonanal. The gin replica can contain less than about 0.088 wt % of the one or more terpenes.

In another aspect, this document features a method for making a gin replica, where the method includes combining water; a grain neutral spirit; glycerin; optionally, a sugar; optionally, a plant oil, fruit oil, plant flavor, or fruit flavor; and at least three added VOCs, wherein the VOCs are provided as separate ingredients and include one or more terpenes and one or more esters, and wherein the added VOCs comprise about 0.001 wt % to about 1 wt % of the gin replica. The one or more terpenes can include one or more of alpha-pinene, d-camphor, d-limonene, eucalyptol, gamma-terpinene, beta-humulene, L-bornyl acetate, linalool, p-cymene, beta-pinene, and terpinolene. The one or more terpenes can include one or more of gamma-terpinene, beta-humulene, linalool, p-cymene, and beta-pinene. The one or more terpenes can include one or more of alpha-pinene, d-camphor, d-limonene, eucalyptol, gamma-terpinene, linalool, p-cymene, beta-pinene, and terpinolene. The one or more terpenes can include one or more of alpha-pinene, d-camphor, eucalyptol, gamma-terpinene, beta-humulene, L-bornyl acetate, linalool, p-cymene, and beta-pinene. The one or more terpenes can include one or more of d-limonene, gamma-terpinene, linalool, and p-cymene. The one or more esters can include one or more of hexyl acetate, ethyl hexanoate, and isobutyl angelate. The one or more esters can include ethyl hexanoate. The added VOCs can further include one or more aldehydes. The one or more aldehydes can include nonanal. The added VOCs can include three or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene. The added VOCs can include five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene. The added VOCs can include ethyl hexanoate, gamma-terpinene, beta-humulene, linalool, p-cymene, and beta-pinene. The added VOCs can include ethyl hexanoate, nonanal, alpha-pinene, d-camphor, d-Limonene, eucalyptol, gamma-terpinene, linalool, p-cymene, beta-pinene, and terpinolene. The added VOCs can include ethyl hexanoate, nonanal, alpha-pinene, d-camphor, eucalyptol, gamma-terpinene, beta-humulene, L-bornyl acetate, linalool, p-cymene, and beta-pinene. The added VOCs can include hexyl acetate, ethyl hexanoate, isobutyl angelate, nonanal, d-limonene, gamma-terpinene, linalool, and p-cymene.

The added VOCs can include beta-pinene, wherein the beta-pinene is present in the gin replica at a concentration less than about 0.018 mg/L. The added VOCs can include terpinolene, wherein the terpinolene is present in the gin replica at a concentration less than about 0.018 mg/L. The added VOCs can include d-limonene, wherein the d-limonene is present in the gin replica at a concentration less than about 0.01 mg/L. The added VOCs can include gamma-terpinene, wherein the gamma-terpinene is present in the gin replica at a concentration less than about 0.0056 mg/L. The added VOCs can include linalool, wherein the linalool is present in the gin replica at a concentration less than about 0.5 mg/L. The added VOCs can include d-camphor, wherein at least about 0.2 wt % of the added VOCs is d-camphor. The added VOCs can include nonanal, wherein the at least about 0.03 wt % of the added VOCs is nonanal. The gin replica can contain less than about 0.088 wt % of the one or more terpenes. The method can include adding a sugar selected from the group consisting of sucrose, fructose, and glucose. The can include adding a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil. The gin replica can contain from about 5 wt % to about 70 wt % water; from about 30 wt % to about 95 wt % grain neutral spirits; from about 0.1 wt % to about 5 wt % glycerin; and from about 0.001 wt % to about 1 wt % added VOCs, wherein the added VOCs include five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

In another aspect, this document features a gin replica produced by a method described herein.

This document also features a gin-like alcoholic beverage concentrate. The concentrate can contain, consist essentially of, or consist of glycerin; optionally, a sugar; optionally, a plant oil, fruit oil, plant flavor, or fruit flavor; and at least three added VOCs, wherein the added VOCs include at least one terpene and at least one ester, and wherein at least one of the added VOCs is present in a concentration of at least about 2-fold the concentration of the same VOC in a corresponding traditional gin or a corresponding non-concentrate gin. At least one of the added VOCs can be present in the concentrate in a concentration of at least about 5-fold the concentration of the same VOCs in a corresponding traditional gin or a corresponding non-concentrate gin. At least one of the added VOCs can be present in the concentrate in a concentration of at least about 10-fold the concentration of the same VOCs in a corresponding traditional gin or a corresponding non-concentrate gin. At least one of the added VOCs can be present in the concentrate in a concentration of at least about 15-fold the concentration of the same VOCs in a corresponding traditional gin or a corresponding non-concentrate gin. Upon dilution of the gin-like beverage concentrate to a gin-like alcoholic beverage, the gin-like alcoholic beverage can be a gin replica described herein.

In another aspect, this document features a method of making a gin-like alcoholic beverage concentrate. The method can include, or consist essentially of, combining glycerin; optionally, a sugar; optionally, a plant oil, fruit oil, plant flavor, or fruit flavor; and at least three added VOCs, wherein the added VOCs include at least one terpene and at least one ester, and wherein at least one of the added VOCs is present in a concentration of at least about 2-fold the concentration of the same VOC in a corresponding traditional gin or a corresponding non-concentrate gin. At least one of the added VOCs can be present in the concentrate in a concentration of at least about 5-fold the concentration of the same VOCs in a corresponding traditional gin or a corresponding non-concentrate gin. At least one of the added VOCs can be present in the concentrate in a concentration of at least about 10-fold the concentration of the same VOCs in a corresponding traditional gin or a corresponding non-concentrate gin. At least one of the added VOCs can be present in the concentrate in a concentration of at least about 15-fold the concentration of the same VOCs in a corresponding traditional gin or a corresponding non-concentrate gin. Upon dilution of the gin-like beverage concentrate to a gin-like alcoholic beverage, the gin-like alcoholic beverage can be a gin replica provided herein.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the description below. Other features, objects, and advantages of the invention will be apparent from the description and from the claims.

### DETAILED DESCRIPTION

This document provides gin-like alcoholic beverages (also referred to as “gin replicas,” “gin products,” and “flavored gins”), as well as methods for making gin-like alcoholic beverages by combining water and ethanol with individual VOCs. Going forward in this document, the term “gin” refers to both “gin” and “gin” spirits.

The gin-like alcoholic beverages described herein have characteristics—including taste, aroma, mouthfeel, and appearance—of traditionally produced gins, and are meant to be consumed and enjoyed in the same manner as traditional gins. For example, the gin replicas can have colors consistent with those of traditional gins.

As used herein, the terms “traditional” and “reference” gin refer to gin produced through standard processing, fermenting, and distilling processes.

The following standards of identity for traditionally produced distilled neutral spirits are set forth in 27 C.F.R. § 5.22(a):

Class 1; neutral spirits or alcohol. “Neutral spirits” or “alcohol” are distilled spirits produced from any material at or above 1900 proof, and, if bottled, bottled at not less than 80° proof.

The following standards of identity for traditionally produced gins are further set forth in 27 C.F.R. § 5.22(c):

Class 3; gin. “Gin” is a product obtained by original distillation from mash, or by redistillation of distilled spirits, or by mixing neutral spirits, with or over juniper berries and other aromatics, or with or over extracts derived from infusions, percolations, or maceration of such materials, and includes mixtures of gin and neutral spirits. It shall derive its main characteristic flavor from juniper berries and be bottled at not less than 800 proof. Gin produced exclusively by original distillation or by redistillation may be further designated as “distilled.” “Dry gin” (London dry gin), “Geneva gin” (Hollands gin), and “Old Tom gin” (Tom gin) are types of gin known under such designations.

In some cases, the alcoholic beverages provided herein can contain a traditional gin. In such embodiments, about 1% to about 5% of the ethanol in a gin replica, on a proof gallon basis, can be from a traditional gin. For example, 1% to 5% (e.g., 1% to 2%, 2% to 3%, 3% to 4%, or 4% to 5%) of the ethanol in a gin replica, on a proof gallon basis, can be from a traditional gin. In some cases, the alcoholic beverages provided herein do not contain any traditional gin.

A “proof gallon” is one liquid gallon of spirits that is 50% alcohol at 60° F. Thus, for example, a distilled spirit bottled at 80 proof (40% alcohol) would be 0.8 proof gallons per gallon of liquid. An 80 proof spirit gin replica containing 1% ethanol from a traditional gin on a proof gallon basis therefore would contain 0.8×0.01=0.008 proof gallon from the traditional gin.

The gin replicas described herein can contain particular volatile and, optionally, non-volatile organic compounds. The terms “contain,” “include,” “comprise” are used herein to indicate that a compound is present in a gin replica in an amount that is detectable (e.g., using a mass spectrometry method, such as gas chromatography mass spectrometry). The terms “lacks,” “does not contain,” “does not include,” and “does not comprise” are used herein to indicate that a compound is not detectable in a gin replica (e.g., using a mass spectrometry method, such as liquid chromatography mass spectrometry). The gin replicas provided herein can be distinguished from traditional gins based at least in part on the combination of VOCs and, in some cases, non-volatile organic compounds contained or not contained therein, and/or based on the amounts of particular VOCs or, in some cases, non-volatile organic compounds contained therein.

In some embodiments, a gin replica can consist of the ingredients included in a particular list, or can have a VOC content (or non-volatile compound content) that consists of the VOCs (or non-volatile compounds) included in a particular list. Further, a gin replica can consist essentially of the ingredients included in a particular list, or can have a VOC content (or non-volatile compound content) that consists essentially of the VOCs (or non-volatile compounds) that are included in a particular list. By “consisting essentially of” is meant that a gin replica contains specified ingredients/VOCs/non-volatile compounds, and can contain additional ingredients/VOCs/non-volatile compounds that do not materially affect the basic and novel characteristics of the gin.

Various formulations for gin replicas are described herein. In general, the gin replicas include the following components, or classes of components:
(a) a source of water, either pure or with mineral content present to improve flavor;
(b) a source of ethanol (e.g., a distilled or fermented ethanol, such as grain neutral spirits);
(c) optionally, a traditional gin, where the traditional gin makes up no more than about 10 wt % of the gin replica;
(d) glycerin;
(e) optionally, sugar;
(f) optionally, one or more added plant oils, fruit oils, plant flavors, or fruit flavors;
(g) one or more additional VOCs (VOCs in addition to the ethanol, and in addition to VOCs that may be present in the traditional gin, plant oil, fruit oil, plant flavor, and fruit flavor, if included); and optionally
(h) one or more additional non-volatile compounds (that is, one or more non-volatile compounds in addition to any non-volatile compounds that may be present in the traditional gin, plant oil, fruit oil, plant flavor, and fruit flavor, if included), such as or more coloring agents.

Water is the main component of the gin replicas, acting as a solvent for the other ingredients. The ethanol component and the gin component (if any) provide the alcoholic content. The one or more added VOCs and the optional sugar and optional one or more plant oils, fruit oils, plant flavors, or fruit flavors can provide both aroma and flavor, including fruity, floral, earthy, herbaceous, oak, yeast, spice, and/or mineral aromas and flavors. In some cases, non-volatile components also can be included, and can provide acidity, flavor, aftertaste, and mouthfeel perception of the gin replicas.

In general, the gin replicas provided herein can have a water content of about 5 to about 70 wt %. For example, a gin replica can have a water content of about 5 to 10 wt %, about 10 to 20 wt %, about 20 to 30 wt %, about 30 to 40 wt %, about 40 to 45 wt %, about 45 to 50 wt %, about 50 to 55 wt %, about 55 to 60 wt %, about 60 to 65 wt %, or about 65 to 70 wt %.

In some embodiments, a gin replica can include water, ethanol, a traditional gin, glycerin, optionally a sugar, optionally an added plant oil, fruit oil, plant flavor, or fruit flavor, and (a) one or more additional VOCs (i.e., VOCs in addition to ethanol and any VOCs included in the traditional gin, plant oil, fruit oil, plant flavor, and fruit flavor, if included), where the one or more additional VOCs are not present in a corresponding reference gin (also sometimes herein called a corresponding traditional gin); (b) one or more additional VOCs (i.e., VOCs in addition to ethanol and any VOCs included in the traditional gin, plant oil, fruit oil, plant flavor, and fruit flavor, if included), where the one or more additional VOCs do not include one or more VOCs that are present in a corresponding reference gin; (c) one or more additional non-volatile compounds (i.e., one or more non-volatile compounds in addition to any non-volatile compounds present in the traditional gin, plant oil, fruit oil, plant flavor, and fruit flavor, if included), where the one or more additional non-volatile compounds are not present in a corresponding reference gin; (d) one or more additional non-volatile compounds (i.e., one or more non-volatile compounds in addition to any non-volatile compounds present in the traditional gin, plant oil, fruit oil, plant flavor, and fruit flavor, if included), where the one or more additional non-volatile compounds do not include one or more non-volatile compounds that are present in a corresponding reference gin; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

As used herein, a “corresponding reference gin” can be a single type, a single brand, or a single bottle of traditionally-produced gin that a gin replica as described herein is intended to replicate. In some cases, a single type, single brand, or single bottle of traditionally-produced gin can be a blend of two or more (e.g., two, three, four, or more than four) brandies. For example, if a gin replica is meant to be the same as a London dry gin, then a London dry gin would be a corresponding reference gin.

In general, the gin replicas provided herein can have a total alcohol content (e.g., an ethanol content from grain neutral spirits and, if present, traditional gin) content that ranges from about 30 wt % to about 95 wt %. For example, a gin replica can have an alcohol content of about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt %.

In some cases, the gin replicas provided herein can contain about 30 wt % to about 95 wt % grain neutral spirits (e.g., about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt % grain neutral spirits) and, if included, about 0.1 wt % to about 10 wt % traditional gin (e.g., about 0.1 wt %, about 0.25 wt %, about 0.5 wt %, about 0.75 wt %, about 1 wt %, about 1.25 wt %, about 1.5 wt %, about 2 wt %, about 3 wt %, about 5 wt %, about 10 wt %, about 0.1 to 0.25 wt %, about 0.25 to 0.5 wt %, about 0.5 to 0.75 wt %, about 0.75 to 1 wt %, about 1 to 1.25 wt %, about 1.25 to 1.5 wt %, about 1.5 to 2 wt %, about 2 to 3 wt %, about 3 to 5 wt %, about 5 to 10 wt %, no more than about 1 wt %, no more than about 2 wt %, no more than about 3 wt %, no more than about 5 wt %, or no more than about 10 wt % traditional gin).

The gin replicas provided herein can contain about 0.1 wt % to about 5 wt % glycerin, which can contribute to the mouthfeel and viscosity/body of the gin replicas, and can provide sweetness. For example, a gin replica can contain glycerin in an amount of about 0.1 wt %, about 0.5 wt %, about 1 wt %, about 1.5 wt %, about 2 wt %, about 2.5 wt %, about 3 wt %, about 4 wt %, about 5 wt %, about 0.1 to 0.5 wt %, about 0.5 to 1 wt %, about 1 to 1.5 wt %, about 1.5 to 2 wt %, about 2 to 3 wt %, about 3 to 4 wt %, or about 4 to 5 wt %.

In some cases, the gin replicas provided herein can contain one or more sugars (e.g., sucrose, fructose, glucose, or any combination thereof). The one or more sugars can be included in an amount from about 0.1 wt % to about 10 wt %. For example, a gin replica can contain about 0.1 wt %, about 0.5 wt %, about 1 wt %, about 1.5 wt %, about 2 wt %, about 2.5 wt %, about 3 wt %, about 4 wt %, about 5 wt %, about 6 wt %, about 7 wt %, about 8 wt %, about 9 wt %, about 10 wt %, about 0.1 to 0.5 wt %, about 0.5 to 1 wt %, about 1 to 1.5 wt %, about 1.5 to 2 wt %, about 2 to 3 wt %, about 3 to 4 wt %, about 4 to 5 wt %, about 5 to 6 wt %, about 6 to 7 wt %, about 7 to 8 wt %, about 8 to 9 wt %, or about 9 to 10 wt % sugar. In some cases, a gin replica provided herein contains no sugar.

In some cases, the gin replicas provided herein can contain one or more plant or fruit oils (e.g., rosemary oil, orange oil, thyme oil, pine oil, or a combination thereof), and/or one or more plant- or fruit-derived flavors (e.g., chamomile flavor, elderflower flavor, geranium flavor, mandarin flavor, orange flavor, or pine flavor). The one or more plant oils can be included in a total amount of about 0.001 wt % to about 0.5 wt % (e.g., about 0.001 wt %, about 0.002 wt %, about 0.003 wt %, about 0.005 wt %, about 0.008 wt %, about 0.01 wt %, about 0.05 wt %, about 0.1 wt %, about 0.25 wt %, about 0.5 wt %, about 0.001 to about 0.002 wt %, about 0.002 to about 0.005 wt %, about 0.005 to about 0.007 wt %, about 0.007 to about 0.01 wt %, about 0.01 to 0.025 wt %, or about 0.025 to 0.05 wt %). In some cases, a gin replica provided herein contains no plant oil, fruit oil, plant-derived flavor, or fruit-derived flavor.

The gin replicas provided herein also contain one or more additional VOCs, where the additional VOCs were added to the gin replica on an individual basis (e.g., in pure or substantially pure form). The one or more added VOCs that are present in a gin replica can include one or more compounds that fall into different categories, including terpenes, aldehydes, esters, and benzenes, for example. In some cases, for example, a gin replica can contain one or more added VOCs that include at least one aldehyde and at least one terpene, at least one aldehyde and at least one ester, at least one ester and at least one terpene, or at least one aldehyde, at least one terpene, and at least one ester. The additional VOCs can be present at any suitable amount within a gin replica. For example, additional VOCs can make up about 0.0001 wt % to about 1 wt % (e.g., about 0.0001 to about 0.0005 wt %, about 0.0005 to about 0.001 wt %, about 0.001 to about 0.005 wt %, about 0.005 to about 0.01 wt %, about 0.01 to about 0.05 wt %, about 0.05 to about 0.1 wt %, about 0.1 to about 0.5 wt %, or about 0.5 to about 1 wt %) of a gin replica.

Aldehydes also can provide flavors that add to the general character of an alcoholic beverage. Non-limiting examples of aldehydes that can be included in the gin replicas provided herein include cuminaldehyde and nonanal. Any appropriate number of aldehydes can be included (for example, 1 to 25, 1 to 10, 1 to 5, 5 to 25, 5 to 10, or 10 to 25 aldehydes). The aldehyde(s) can make up any suitable proportion of the additional VOC content. For example, about 0.0001% to about 50% (e.g., about 0.001% to about 0.01%, about 0.01% to about 0.1%, about 0.1% to about 1%, about 1% to about 10%, about 10% to about 20%, about 20% to about 25%, about 25% to about 30%, about 30% to about 40%, or about 40% to about 50%) by mass of the additional VOCs can comprise one or more aldehydes. The one or more aldehyde(s) can be present at any suitable amount within a gin replica. In some cases, for example, added aldehyde(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a gin replica. In some cases, the additional VOCs can include no aldehydes.

Terpenes can contribute various floral and green characteristics to an alcoholic beverage. Non-limiting examples of terpenes that can be included in the gin replicas provided herein include alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, alpha-phellandrene, camphene, dehydrosabinene, eucalyptol, beta-humulene, isoborneol, L-bornyl acetate, terpinolene, alpha-terpinyl acetate, and any combination thereof. For example, in some cases, a gin replica can contain one or more terpenes selected from the group consisting of alpha-pinene, d-camphor, d-limonene, eucalyptol, gamma-terpinene, beta-humulene, L-bornyl acetate, linalool, p-cymene, beta-pinene, and terpinolene. In some cases, a gin replica can contain gamma-terpinene, beta-humulene, linalool, p-cymene, beta-pinene. In some cases, a gin replica can contain alpha-pinene, d-camphor, d-limonene, eucalyptol, gamma-terpinene, linalool, p-cymene, beta-pinene, and terpinolene. In some cases, a gin replica can contain alpha-pinene, d-camphor, eucalyptol, gamma-terpinene, beta-humulene, L-bornyl acetate, linalool, p-cymene, beta-pinene. In some cases, a gin replica can contain d-limonene, gamma-terpinene, linalool, and p-cymene. Any appropriate number of terpenes can be included (for example, 1 to 25, 1 to 10, 1 to 5, 5 to 25, 5 to 10, or 10 to 25 terpenes). The terpene(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more terpenes. The one or more terpenes can be present at any suitable amount within a gin replica. In some cases, for example, added terpene(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a gin replica. In some cases, terpenes can be present in a gin replica in a total amount less than about 0.088 wt % (e.g., less than about 0.08 wt %, less than about 0.05 wt %, less than about 0.005 wt %, about 0.001 to about 0.008 wt %, or about 0.08 to about 0.088 wt %). In some cases, the additional VOCs can include no terpenes.

Esters, including ethyl, methyl, and acetate esters, can contribute fruity and floral characteristics to an alcoholic beverage. Examples of esters that can be used in a gin replica include, without limitation, hexyl acetate, ethyl hexanoate, isobutyl angelate, ethyl octanoate, and any combination thereof. In some cases, for example a gin replica can contain hexyl acetate, ethyl hexanoate, and isobutyl angelate. In some cases, a gin replica can contain ethyl hexanoate. Any appropriate number of esters can be used (for example, 1 to 25, 1 to 10, 1 to 5, 5 to 25, 5 to 10, or 10 to 25 esters). In some cases, the one or more esters can be present in a total amount of about 0.0001 mg/L to about 1 mg/L (e.g., about 0.0001 to about 0.0005 mg/L, about 0.0005 to about 0.001 mg/L, about 0.001 to about 0.005 mg/L, about 0.05 to about 0.1 mg/L, about 0.1 to about 0.5 mg/L, or about 0.5 to about 1 mg/L). The ester(s) can make up any suitable proportion of the additional VOC content. For example, about 0.01% to about 99% (e.g., about 0.01 to about 0.1%, about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more esters. The one or more esters can be present at any suitable amount within a gin replica. In some cases, for example, added ester(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a gin replica. In some cases, the additional VOCs can include no esters.

Benzenes can contribute plastic and aromatic characteristics to an alcoholic beverage. In some cases, benzenes that can be used in a gin replica include, without limitation, 1,3-di-tert-butylbenzene, naphthalene, or a combination thereof Δny appropriate number of benzenes can be used (for example, 1 to 10, 1 to 5, or 5 to 10 benzenes). In some cases, the one or more benzenes can be present in a total amount of about 0.0001 mg/L to about 0.1 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.1 mg/L). The benzene(s) can make up any suitable proportion of the additional VOC content. For example, about 0.01% to about 99% (e.g., about 0.01 to about 0.1%, about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more benzenes. The one or more benzenes can be present at any suitable amount within a gin replica. In some cases, for example, added benzene(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a gin replica. In some cases, the additional VOCs can include no benzenes.

In some embodiments, the gin replicas provided herein can include one or more (e.g., one, two, three, four, five, six, seven eight, nine, ten, or more than ten) VOCs that are not present in a corresponding traditional gin. A non-limiting example of such a compound is hexyl acetate. Thus, in some embodiments, a gin replica can include hexyl acetate. It is surprising that the gin replicas described herein include one or more compounds not found in any tested traditional gin, as it would be expected that to create a gin replica, one would only think to use compounds found in one or more traditional gins. By way of example only, hexyl acetate, on its own, has fatty characteristics. However, in low concentrations in a gin replica (e.g., any of the gin replicas provided herein), it can provide fruity and/or sweet characteristics (e.g., providing green apple or banana flavors or aromas).

In some embodiments, the additional VOCs can exclude one or more VOCs that are present in a corresponding traditional gin. Examples of VOCs that can be excluded from the gin replicas provided herein include, without limitation, beta-selinene, beta-elemene, and caryophyllene. It is surprising that the gin replicas described herein lack one or more compounds found in every tested traditional gin, as it would be expected that to create a gin replica, one would believe that compounds present in every tested traditional gin to be important to gin flavor.

A gin replica can include any appropriate number of additional VOCs. For example, a gin replica can include from 1 to 35 (e.g., at least 5, at least 10, at least 20, at least 30, 1 to 35, 1 to 30, 1 to 20, 1 to 10, 1 to 5, 5 to 35, 5 to 30, 5 to 20, 5 to 10, 10 to 35, 10 to 30, 10 to 20, 20 to 35, 20 to 30, 20 to 25, or 30 to 35) additional VOCs. For example, in some embodiments, a gin replica can include 1 to 35 (e.g., at least 5, at least 10, at least 20, at least 30, 1 to 35, 1 to 30, 1 to 20, 1 to 10, 1 to 5, 5 to 35, 5 to 30, 5 to 20, 5 to 10, 10 to 35, 10 to 30, 10 to 20, 20 to 35, 20 to 30, 20 to 25, or 30 to 35) additional VOCs selected from the group consisting of 1,3-di-tert-butylbenzene, 3-carene, 4-carvomenthenol, alpha-phellandrene, alpha-pinene, alpha-terpineol, alpha-terpinolene, alpha-terpinyl acetate, beta-caryophyllene, beta-humulene, beta-myrcene, beta-pinene, camphene, citronellal, citronellol, cuminaldehyde, d-camphor, dehydrosabinene, d-limonene, ethyl hexanoate, ethyl octanoate, eucalyptol, gamma-terpinene, geraniol, hexyl acetate, isoborneol, isobutyl angelate, L-bornyl acetate, linalool, naphthalene, nerol, nonanal, p-cymene, and terpinolene. In some cases, a gin replica can include from one to 25 (e.g., one, two, three, four, five, six, seven, eight, nine, ten, 11, 12, 13, 14, 15, 16, 17, 18, 19, 20, 21, 22, 23, 24, 25 at least three, at least five, at least ten, at least 15, at least 20, one to three, three, to five, five to ten, ten to 15, 15 to 20, or 20 to 25) additional VOCs selected from the group consisting of 1,3-di-tert-butylbenzene, alpha-phellandrene, alpha-pinene, alpha-terpinyl acetate, beta-caryophyllene, beta-humulene, beta-myrcene, beta-pinene, camphene, d-camphor, dehydrosabinene, d-limonene, ethyl hexanoate, ethyl octanoate, eucalyptol, gamma-terpinene, hexyl acetate, isoborneol, isobutyl angelate, L-bornyl acetate, linalool, naphthalene, nonanal, p-cymene, and terpinolene. In some cases, a gin replica can include from one to 15 (e.g., one, two, three, four, five, six, seven, eight, nine, ten, 11, 12, 13, 14, 15, at least three, at least five, at least ten, at least 12, one to three, three, to five, five to ten, or ten to 15) additional VOCs selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

In some cases, a gin replica can include 1 to 6 (e.g., at least 2, at least 3, at least 4, at least 5, 1 to 2, 1 to 3, 1 to 4, 2 to 3, 2 to 4, 2 to 5, or 3 to 5) additional VOCs selected from the group consisting of ethyl hexanoate, gamma-terpinene, beta-humulene, linalool, p-cymene, and beta-pinene. For example, in some cases, a gin-like alcoholic beverage can include at least six added VOCs, where the at least six added VOCs include ethyl hexanoate, gamma-terpinene, beta-humulene, linalool, p-cymene, and beta-pinene.

In some cases, a gin replica can include 1 to 11 (e.g., at least 2, at least 3, at least 4, at least 5, at least 6, at least 7, at least 8, at least 9, at least 10, 1 to 3, 1 to 5, 2 to 4, 3 to 5, 3 to 7, 4 to 6, 5 to 7, 5 to 10, 6 to 8, 7 to 9, 8 to 10, or 9 to 11) additional VOCs selected from the group consisting of ethyl hexanoate, nonanal, alpha-pinene, d-camphor, d-Limonene, eucalyptol, gamma-terpinene, linalool, p-cymene, beta-pinene, and terpinolene. For example, in some cases, a gin-like alcoholic beverage can include at least 11 added VOCs, where the at least 11 added VOCs include ethyl hexanoate, nonanal, alpha-pinene, d-camphor, d-Limonene, eucalyptol, gamma-terpinene, linalool, p-cymene, beta-pinene, and terpinolene.

In some cases, a gin replica can include 1 to 11 (e.g., at least 2, at least 3, at least 4, at least 5, at least 6, at least 7, at least 8, at least 9, at least 10, 1 to 3, 1 to 5, 2 to 4, 3 to 5, 3 to 7, 4 to 6, 5 to 7, 5 to 10, 6 to 8, 7 to 9, 8 to 10, or 9 to 11) additional VOCs selected from the group consisting of ethyl hexanoate, nonanal, alpha-pinene, d-camphor, eucalyptol, gamma-terpinene, beta-humulene, L-bornyl acetate, linalool, p-cymene, and beta-pinene. For example, in some cases, a gin-like alcoholic beverage can include at least 11 added VOCs, where the at least 11 added VOCs include ethyl hexanoate, nonanal, alpha-pinene, d-camphor, eucalyptol, gamma-terpinene, beta-humulene, L-bornyl acetate, linalool, p-cymene, and beta-pinene.

In some cases, a gin replica can include 1 to 6 (e.g., at least 2, at least 3, at least 4, at least 5, 1 to 2, 1 to 3, 1 to 4, 2 to 3, 2 to 4, 2 to 5, or 3 to 5) additional VOCs selected from the group consisting of hexyl acetate, ethyl hexanoate, isobutyl angelate, nonanal, d-limonene, gamma-terpinene, linalool, and p-cymene. For example, in some cases, a gin-like alcoholic beverage can include at least six added VOCs, where the at least six added VOCs include hexyl acetate, ethyl hexanoate, isobutyl angelate, nonanal, d-limonene, gamma-terpinene, linalool, and p-cymene.

A gin replica provided herein can include VOCs in any appropriate amount. For example, in some embodiments, the additional VOCs can be present in a total amount of about 0.01 mg/L to about 10 mg/L (e.g., about 0.01 to about 0.1 mg/L, about 0.1 to about 0.5 mg/L, about 0.5 to about 1 mg/L, about 0.5 to about 1.5 mg/L, about 1 to about 2 mg/L, about 2 to about 3 mg/L, about 3 to about 4 mg/L, or about 4 to about 5 mg/L).

In some cases, the number of additional VOCs in a gin replica can be fewer than the number of additional VOCs in a single corresponding reference gin. Further, in some embodiments, the gin replicas provided herein can lack one or more (e.g., one, two, three, four, five, ten, 15, 20, or more than 20) VOCs that are present in a corresponding traditional gin. In some cases, the overall population of additional (non-ethanol) VOCs in a gin replica can have less than 95% identity to the VOCs in a corresponding reference gin (e.g., in a single type of traditionally made gin corresponding to the replica). For example, the additional VOCs in a gin replica can have less than 90%, less than 80%, less than 70%, less than 60%, less than 50%, less than 40%, less than 30%, less than 25%, less than 20%, or less than 15% identity to the population of VOCs in a corresponding reference gin made by traditional methods. In some cases, a percent identity can be calculated by dividing the number of shared additional VOCs by the number of additional VOCs in the corresponding reference gin. Some gin replicas may contain at least 3 (e.g., at least 5, at least 7, or at least 10) VOCs that are not found in a single reference gin. Moreover, some gin replicas may contain no more than 50 (e.g., no more than 45, 40, 35, 30, 25, 20, 15, or 10) VOCs that are present in a single reference gin. For example, in some embodiments, a gin replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference gin; in some embodiments, n can be equal to 5, 6, 7, 8, 9, 10, 11, 12, 13, 14, 15, 16, 17, 18, 19, 20, 25, 30, 35, 40, 45, or 50.

The presence, absence, and/or amount of VOCs and non-volatile compounds in traditional gins (also referred to as “reference gins”) and in gin replicas is assessed using gas chromatography/mass spectrometry (GC-MS) and liquid chromatography/mass spectrometry (LC-MS) methods, respectively. A volatile or non-volatile compound that is “not present” in a reference gin is one that is not detected in the reference gin using the methods set forth in Example 3. Limits of detection for various VOCs are disclosed in TABLES 2A and 2B herein.

As noted above, the amounts of VOCs in reference gins are measured using the GC-MS methods described herein. In some embodiments, the amount of a particular VOC in a gin replica can be an amount, based on concentration or percent composition, that is within a range 30% higher and lower than a measured amount for that VOC in a corresponding reference gin. For example, a VOC can be present in a gin replica in an amount that is 70 to 90%, 80 to 100%, 90 to 110%, 100 to 120%, 110 to 130%, 70 to 100%, 80 to 110%, 90 to 120%, or 100 to 130% of an amount measured for that VOC in a corresponding reference gin.

In some embodiments, a percent composition of VOCs can be calculated by dividing the measured amount of a VOC of interest (e.g., in mg/L) by the total measured amount of VOCs (e.g., in mg/L). In some cases, the total measured amount of VOCs is based on the VOCs in TABLES 1A-1D. In some cases, the total measured amount of VOCs is based on the total measured amount of 1,3-di-tert-butylbenzene, alpha-phellandrene, alpha-pinene, alpha-terpinyl acetate, beta-caryophyllene, beta-humulene, beta-myrcene, beta-pinene, camphene, d-camphor, dehydrosabinene, d-limonene, ethyl hexanoate, ethyl octanoate, eucalyptol, gamma-terpinene, hexyl acetate, isoborneol, isobutyl angelate, L-bornyl acetate, linalool, naphthalene, nonanal, p-cymene, and terpinolene. In some embodiments, the total measured amount of VOCs is based on the total measured amount of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene. In some embodiments, the total measured amount of VOCs is based on the total measured amount of ethyl hexanoate, gamma-terpinene, beta-humulene, linalool, p-cymene, and beta-pinene. In some embodiments, the total measured amount of VOCs is based on the total measured amount of ethyl hexanoate, nonanal, alpha-pinene, d-camphor, d-Limonene, eucalyptol, gamma-terpinene, linalool, p-cymene, beta-pinene, and terpinolene. In some embodiments, the total measured amount of VOCs is based on the total measured amount of ethyl hexanoate, nonanal, alpha-pinene, d-camphor, eucalyptol, gamma-terpinene, beta-humulene, L-bornyl acetate, linalool, p-cymene, and beta-pinene. In some embodiments, the total measured amount of VOCs is based on the total measured amount of hexyl acetate, ethyl hexanoate, isobutyl angelate, nonanal, d-limonene, gamma-terpinene, linalool, and p-cymene.

In some cases, the total amount of VOCs in a gin replica can be less than the total amount of VOCs in a reference gin. For example, a gin replica can have a total VOC content (in mg/L) that is less than 95% (e.g., less than 90%, 85%, 80%, 70%, 60%, 50% or 40%) of the total VOC content (in mg/L) of a corresponding reference gin.

In some cases, the total amount of VOCs in a gin replica can be less than the total amount of VOCs in a corresponding reference gin. Further, the amount of any particular VOC in a gin replica may be different than the amount of that VOC in a corresponding reference gin. In some cases, the amount of a VOC in a gin replica can be 75% or less (e.g., 70% or less, 60% or less, 50% or less, 40% or less, 30% or less, 20% or less, or 10% or less), by concentration or percent mass, than the amount of the same VOC in a corresponding reference gin. In some cases, the amount of a VOC in a gin replica can be 125% or more (e.g., 150% or more, 200% or more, or 300% or more), by concentration or percent mass, than the amount of the same VOC in a corresponding reference gin.

It will be understood that when both a range (or subrange) and an “at least” or “less than” amount (or percent by mass) are disclosed, these together disclose all ranges that exist in the overlap of the range (or subrange) and one of the “at least” or “less than” values in any combination. By way of example only, beta-humulene can be present in an amount of about 0.0076 mg/L to about 1.34 mg/L, and the one or more additional VOCs can include beta-humulene in an amount of at least about 0.12 mg/L. Therefore, beta-humulene can be present in an amount of about 0.12 mg/L to about 1.34 mg/L (e.g., about 0.12 to about to about 0.25 mg/L, about 0.12 to about 0.5 mg/L, about 0.12 to about 1 mg/L, or about 0.12 to about 1.34 mg/L); beta-humulene can be present in an amount of about 0.3 mg/L to about 1.34 mg/L (e.g., about 0.3 to about 0.6 mg/L, about 0.3 to about 1 mg/L, or about 0.3 to about 1.34 mg/L); beta-humulene can be present in an amount of about 0.8 mg/L to about 1.34 mg/L (e.g., about 0.8 to about 1.1 mg/L, or about 1.1 to about 1.34 mg/L); or beta-humulene can be present in an amount of about 1 mg/L to about 1.34 mg/L.

Further, it will be understood that if both a range and an “at least” or “less than” value are described for a gin replica, the interpretation will be the largest overlap of those descriptions. For example, if a gin replica is described with both “beta-humulene can be present in an amount of about 0.0076 mg/L to about 1.34 mg/L” and “the one or more additional VOCs include beta-humulene in an amount of at least about 0.12 mg/L,” the interpretation shall be that beta-humulene is present in an amount of about 0.12 mg/L to about 1.34 mg/L.

In some cases, the one or more additional VOCs in a gin-like alcoholic beverage can include alpha-pinene. The alpha-pinene can be present in a gin-like alcoholic beverage in an amount of, for example, about 0.001 to about 27.0 mg/L (e.g. about 0.001 to about 0.1 mg/L, about 0.1 to about 1.0 mg/L, about 1.0 to about 5.0 mg/L, about 5.0 to about 10.0 mg/L, about 10.0 to about 15.0 mg/L, about 15.0 to about 20.0 mg/L, about 20.0 to about 25.0 mg/L, or about 25.0 to about 27.0 mg/L). The alpha-pinene can be present in a gin-like alcoholic beverage in an amount of, for example, 0.00074 wt % to about 0.0014 wt % (e.g., about 0.00074 to about 0.0008 wt %, about 0.0008 to about 0.0009 wt %, about 0.0009 to about 0.001 wt %, about 0.001 to about 0.0012 wt %, or about 0.0012 to about 0.0014 wt %). In some cases, about 0.0014 wt % to about 84.5 wt % (e.g., about 0.0014 wt % to about 0.01 wt %, about 0.01 wt % to about 0.1 wt %, about 0.1 wt % to about 1.0 wt %, about 1.0 wt % to about 5.0 wt %, about 5.0 wt % to about 10 wt %, about 10 wt % to about 15 wt %, about 15.0 wt % to about 20 wt %, about 20 wt % to about 25 wt %, about 25.0 wt % to about 30 wt %, about 30 wt % to about 35 wt %, about 35.0 wt % to about 40 wt %, about 40 wt % to about 45 wt %, about 45.0 wt % to about 50 wt %, about 50 wt % to about 55 wt %, about 55.0 wt % to about 60 wt %, about 60 wt % to about 65 wt %, about 65.0 wt % to about 70 wt %, about 70 wt % to about 75 wt %, about 75.0 wt % to about 80 wt %, or about 80 wt % to about 84.5 wt %) of the one or more additional VOCs can be alpha-pinene. In some cases, the one or more additional VOCs can include no alpha-pinene.

In some cases, the one or more additional VOCs in a gin-like alcoholic beverage can include beta-pinene. The beta-pinene can be present in an amount of, for example, about 0.003 to about 0.09 mg/L (e.g. about 0.003 to about 0.03 mg/L, about 0.03 to about 0.06 mg/L, or about 0.06 to about 0.09 mg/L). In some cases, beta-pinene can be present in a gin replica at a concentration less than about 0.018 mg/L (e.g., less than about 0.015 mg/L, or less than about 0.01 mg/L). The beta-pinene can be present in a gin-like alcoholic beverage in an amount of, for example, 0.001 to about 0.0021 wt % (e.g., about 0.001 to about 0.0012 wt %, about 0.0012 to about 0.0014 wt %, about 0.0014 to about 0.0016 wt %, about 0.0016 to about 0.0018 wt %, or about 0.0018 to about 0.0021 wt %). In some cases, about 0.0021 wt % to about 0.93 wt % (e.g., 0.0021 wt % to about 0.02 wt %, about 0.02 wt % to about 0.2 wt %, about 0.2 wt % to about 0.4 wt %, about 0.4 wt % to about 0.6 wt %, about 0.6 wt % to about 0.8 wt %, or about 0.8 wt % to about 0.0.93 wt %) of the one or more additional VOCs can be beta-pinene. In some cases, the one or more additional VOCs can include no beta-pinene.

In some cases, the one or more additional VOCs in a gin-like alcoholic beverage can include 3-carene. The 3-carene can be present in a gin-like alcoholic beverage in an amount of, for example, about 0.00035 wt % to about 0.00065 wt % (e.g., about 0.00035 to about 0.0004 wt %, about 0.0004 to about 0.00045 wt %, about 0.00045 to about 0.0005 wt %, about 0.0005 to about 0.00055 wt %, about 0.00055 to about 0.0006 wt %, or about 0.0006 to about 0.00065 wt %). In some cases, the one or more additional VOCs can include no 3-carene.

In some cases, the one or more additional VOCs in a gin-like alcoholic beverage can include beta-myrcene. The beta-myrcene can be present in an amount of, for example, about 0.02 to about 12.9 mg/L (e.g. about 0.02 to about 0.05 mg/L, about 0.05 to about 0.5 mg/L, about 0.5 to about 1.0 mg/L, about 1.0 to about 3.0 mg/L, about 3.0 to about 6.0 mg/L, about 6.0 to about 9.0 mg/L, or about 9.0 to about 12.9 mg/L). The beta-myrcene can be present in a gin-like alcoholic beverage in an amount of, for example, about 0.0007 wt % to about 0.0015 wt % (e.g., about 0.0007 to about 0.0009 wt %, about 0.0009 to about 0.0011 wt %, about 0.0011 to about 0.0013 wt %, or about 0.0013 to about 0.0015 wt %). In some cases, about 0.0015 wt % to about 61 wt % (e.g., about 0.0015 wt % to about 0.015 wt %, about 0.015 wt % to about 0.15 wt %, about 0.15 wt % to about 1 wt %, about 1.5 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, or about 60 wt % to about 61 wt %) of the one or more additional VOCs can be beta-myrcene. In some cases, the one or more additional VOCs can include no beta-myrcene.

In some cases, the one or more additional VOCs in a gin-like alcoholic beverage can include limonene (e.g., d-limonene). The limonene can be present in an amount of, for example, about 0.0025 to about 27 mg/L (e.g. about 0.0025 to about 0.025 mg/L, about 0.025 to about 0.25 mg/L, about 0.25 to about 2.5 mg/L, about 2.5 to about 5 mg/L, about 5 to about 10 mg/L, about 10 to about 15 mg/L, about 15 to about 20 mg/L, or about 20 to about 27 mg/L). In some cases, limonene can be present at a concentration less than about 0.01 mg/L (e.g., less than about 0.008 mg/L, less than about 0.007 mg/L, or less than about 0.005 mg/L). The limonene can be present in a gin-like alcoholic beverage in an amount of, for example, about 0.00007 wt % to about 0.00013 wt % (e.g., about 0.00007 to about 0.00008 wt %, about 0.00008 to about 0.00009 wt %, about 0.00009 to about 0.0001 wt %, about 0.0001 to about 0.00011 wt %, about 0.00011 to about 0.00012 wt %, or about 0.00012 to about 0.00013 wt %). In some cases, about 0.00013 wt % to about 84 wt % (e.g., 0.00013 wt % to about 0.0013 wt %, about 0.0013 wt % to about 0.013 wt %, about 0.013 wt % to about 0.1 wt %, about 0.1 wt % to about 1 wt %, about 1 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, or about 80 wt % to about 84 wt %) of the one or more additional VOCs can be limonene. In some cases, the one or more additional VOCs can include no limonene.

In some cases, the one or more additional VOCs in a gin-like alcoholic beverage can include gamma-terpinene. The gamma-terpinene can be present in an amount of, for example, about 0.001 to about 2.9 mg/L (e.g., 0.001 to about 0.01 mg/L, about 0.01 to about 0.1 mg/L, about 0.1 to about 1.0 mg/L, about 1.0 to about 1.5 mg/L, about 1.5 to about 2.0 mg/L, about 2.0 to about 2.5 mg/L, or about 2.5 to about 2.9 mg/L). In some cases, gamma-terpinene can be present in a gin replica at a concentration less than about 0.0056 mg/L (e.g., less than about 0.005 mg/L, less than about 0.004 mg/L, or less than about 0.003 mg/L). The gamma-terpinene can be present in a gin-like alcoholic beverage in an amount of, for example, about 0.0002 wt % to about 0.0004 wt % (e.g., about 0.0002 to about 0.00025 wt %, about 0.00025 to about 0.0003 wt %, about 0.0003 to about 0.00035 wt %, or about 0.00035 to about 0.0004 wt %). In some cases, about 0.0004 wt % to about 21.4 wt % (e.g., about 0.0004 wt % to about 0.004 wt %, about 0.004 wt % to about 0.04 wt %, about 0.04 wt % to about 0.4 wt %, about 0.4 wt % to about 4.0 wt %, about 4.0 wt % to about 8.0 wt %, about 8.0 wt % to about 12.0 wt %, about 12.0 wt % to about 16.0 wt %, about 16.0 wt % to about 20.0 wt %, or about 20.0 wt % to about 21.4 wt %) of the one or more additional VOCs can be gamma-terpinene. In some cases, the one or more additional VOCs can include no gamma-terpinene.

In some cases, the one or more additional VOCs in a gin-like alcoholic beverage can include p-cymene. The p-cymene can be present in a gin-like alcoholic beverage in an amount of, for example, about 0.02 to about 12 mg/L (e.g., about 0.02 to about 0.2 mg/L, about 0.2 to about 2.0 mg/L, about 2.0 to about 4.0 mg/L, about 4.0 to about 6.0 mg/L, about 6.0 to about 8.0 mg/L, about 8.0 to about 10.0 mg/L, about 10.0 to about 12.0 mg/L). The p-cymene can be present in a gin-like alcoholic beverage in an amount of, for example, about 0.00017 wt % to about 0.00035 wt % (e.g., about 0.00017 to about 0.0002 wt %, about 0.0002 to about 0.00023 wt %, about 0.00023 to about 0.00026 wt %, about 0.00026 to about 0.00029 wt %, about 0.00029 to about 0.00032 wt %, or about 0.00032 to about 0.00035 wt %). In some cases, about 0.00029 wt % to about 59 wt % (e.g., about 0.00029 wt % to about 0.0029 wt %, about 0.0029 wt % to about 0.029 wt %, about 0.029 wt % to about 0.29 wt %, about 0.29 wt % to about 2.9 wt %, about 2.9 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, or about 55 wt % to about 59 wt %) of the one or more additional VOCs can be p-cymene. In some cases, the one or more additional VOCs can include no p-cymene.

In some cases, the one or more additional VOCs in a gin-like alcoholic beverage can include terpinolene (e.g., alpha-terpinolene). The alpha-terpinolene can be present in a gin-like alcoholic beverage in an amount of, for example, about 0.00057 to about 1.1 mg/L (e.g., about 0.0006 to about 0.006 mg/L, about 0.006 to about 0.06 mg/L, about 0.06 to about 0.6 mg/L, or about 0.6 to about 1.1 mg/L). In some cases, terpinolene can be present in a gin replica at a concentration less than about 0.018 mg/L (e.g., less than about 0.015 mg/L, less than about 0.01 mg/L, or less than about 0.001 mg/L). The alpha-terpinolene can be present in a gin-like alcoholic beverage in an amount of, for example, about 0.00007 wt % to about 0.00013 wt % (e.g., about 0.00007 to about 0.00008 wt %, about 0.00008 to about 0.00009 wt %, about 0.00009 to about 0.0001 wt %, about 0.0001 to about 0.00011 wt %, about 0.00011 to about 0.00012 wt %, or about 0.00012 to about 0.00013 wt %). In some cases, the one or more additional VOCs can include no alpha-terpinolene.

In some cases, the one or more additional VOCs in a gin-like alcoholic beverage can include citronellal. The citronellal can be present in a gin-like alcoholic beverage in an amount of, for example, about 0.000025 wt % to about 0.000055 wt % (e.g., about 0.000025 to about 0.00003 wt %, about 0.00003 to about 0.000035 wt %, about 0.000035 to about 0.00004 wt %, about 0.00004 to about 0.000045 wt %, about 0.000045 to about 0.00005 wt %, or about 0.00005 to about 0.000055 wt %). In some cases, the one or more additional VOCs can include no citronellal.

In some cases, the one or more additional VOCs in a gin-like alcoholic beverage can include d-camphor. The d-camphor can be present in a gin-like alcoholic beverage in an amount of, for example, about 0.08 to about 1.6 mg/L (e.g., about 0.08 to about 0.8 mg/L, about 0.8 to about 1.0 mg/L, or about 1.0 to about 1.6 mg/L). The d-camphor can be present in a gin-like alcoholic beverage in an amount of, for example, about 0.0001 wt % to about 0.0002 wt % (e.g., about 0.0001 to about 0.00012 wt %, about 0.00012 to about 0.00014 wt %, about 0.00014 to about 0.00016 wt %, about 0.00016 to about 0.00018 wt %, or about 0.00018 to about 0.0002 wt %). In some cases, about 0.0002 wt % to about 28 wt % (e.g., about 0.0002 wt % to about 0.002 wt %, about 0.002 wt % to about 0.02 wt %, about 0.02 wt % to about 0.2 wt %, about 0.2 wt % to about 2.0 wt %, about 2.0 wt % to about 5% wt %, about 5 wt % to about 10 wt %, about 10 wt % to about 15 wt %, about 15 wt % to about 20 wt %, about 20 wt % to about 25 wt %, or about 25 wt % to about 28 wt %) of the one or more additional VOCs can be d-camphor. In some cases, at least about 0.2 wt % (e.g., at least about 0.5 wt %, or at least about 1 wt %) of the one or more additional VOCs can be d-camphor. In some cases, the one or more additional VOCs can include no d-camphor.

In some cases, the one or more additional VOCs in a gin-like alcoholic beverage can include linalool. The linalool can be present in a gin-like alcoholic beverage in an amount of, for example, about 0.0007 to about 58 mg/L (e.g., about 0.0007 to about 0.007 mg/L, about 0.007 to about 0.07 mg/L, about 0.07 to about 0.7 mg/L, about 0.7 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, about 35 to about 40 mg/L, about 40 to about 45 mg/L, about 45 to about 50 mg/L, about 50 to about 55 mg/L, or about 55 to about 58 mg/L). In some cases, linalool can be present in a gin replica at a concentration less than about 0.5 mg/L (e.g., less than about 0.1 mg/L, less than about 0.01 mg/L, or less than about 0.001 mg/L). The linalool can be present in a gin-like alcoholic beverage in an amount of, for example, about 0.00018 wt % to about 0.00035 wt % (e.g., about 0.00018 to about 0.00021 wt %, about 0.00021 to about 0.00024 wt %, about 0.00024 to about 0.00027 wt %, about 0.00027 to about 0.0003 wt %, about 0.0003 to about 0.00033 wt %, or about 0.00033 to about 0.00035 wt %). In some cases, about 0.00035 wt % to about 100 wt % (e.g., about 0.00035 wt % to about 0.0035 wt %, about 0.0035 wt % to about 0.035 wt %, about 0.035 wt % to about 0.35 wt %, about 0.35 wt % to about 5.0 wt %, about 5.0 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 100 wt %) of the one or more additional VOCs can be linalool. In some cases, the one or more additional VOCs can include no linalool.

In some cases, the one or more additional VOCs in a gin-like alcoholic beverage can include 4-carvomenthenol. The 4-carvomenthenol can be present in a gin-like alcoholic beverage in an amount of, for example, about 0.00005 wt % to about 0.00011 wt % (e.g., about 0.00005 to about 0.00006 wt %, about 0.00006 to about 0.00007 wt %, about 0.00007 to about 0.00008 wt %, about 0.00008 to about 0.00009 wt %, or about 0.00009 to about 0.00011 wt %). In some cases, the one or more additional VOCs can include no 4-carvomenthenol.

In some cases, the one or more additional VOCs in a gin-like alcoholic beverage can include alpha-terpineol. The alpha-terpineol can be present in a gin-like alcoholic beverage in an amount of, for example, about 0.0006 wt % to about 0.0012 wt % (e.g., about 0.0006 to about 0.0007 wt %, about 0.0007 to about 0.0008 wt %, about 0.0008 to about 0.0009 wt %, about 0.0009 to about 0.001 wt %, about 0.001 to about 0.0011 wt %, or about 0.0011 to about 0.0012 wt %). In some cases, the one or more additional VOCs can include no alpha-terpineol.

In some cases, the one or more additional VOCs in a gin-like alcoholic beverage can include cuminaldehyde. The cuminaldehyde can be present in a gin-like alcoholic beverage in an amount of, for example, about 0.00007 wt % to about 0.00013 wt % (e.g., about 0.00007 to about 0.00008 wt %, about 0.00008 to about 0.00009 wt %, about 0.00009 to about 0.0001 wt %, about 0.0001 to about 0.00011 wt %, about 0.00011 to about 0.00012 wt %, or about 0.00012 to about 0.00013 wt %). In some cases, the one or more additional VOCs can include no cuminaldehyde.

In some cases, the one or more additional VOCs in a gin-like alcoholic beverage can include citronellol. The citronellol can be present in a gin-like alcoholic beverage in an amount of, for example, about 0.00029 wt % to about 0.00055 wt % (e.g., about 0.00029 to about 0.00035 wt %, about 0.00035 to about 0.0004 wt %, about 0.0004 to about 0.00045 wt %, about 0.00045 to about 0.0005 wt %, or about 0.0005 to about 0.00055 wt %). In some cases, the one or more additional VOCs can include no citronellol.

In some cases, the one or more additional VOCs in a gin-like alcoholic beverage can include nerol. The nerol can be present in a gin-like alcoholic beverage in an amount of, for example, about 0.000007 wt % to about 0.000013 wt % (e.g., about 0.000007 to about 0.000008 wt %, about 0.000008 to about 0.000009 wt %, about 0.000009 to about 0.00001 wt %, about 0.00001 to about 0.000011 wt %, about 0.000011 to about 0.000012 wt %, or about 0.000012 to about 0.000013 wt %). In some cases, the one or more additional VOCs can include no nerol.

In some cases, the one or more additional VOCs in a gin-like alcoholic beverage can include geraniol. The geraniol can be present in a gin-like alcoholic beverage in an amount of, for example, about 0.00004 wt % to about 0.00008 wt % (e.g., 0.00004 to about 0.00005 wt %, about 0.00005 to about 0.00006 wt %, about 0.00006 to about 0.00007 wt %, or about 0.00007 to about 0.00008 wt %). In some cases, the one or more additional VOCs can include no geraniol.

In some cases, the one or more additional VOCs in a gin-like alcoholic beverage can include beta-caryophyllene. The beta-caryophyllene can be present in a gin-like alcoholic beverage in an amount of, for example, about 0.013 to about 1.5 mg/L (e.g., about 0.013 to about 0.13 mg/L, about 0.13 to about 1 mg/L, or about 1 to about 1.5 mg/L). The beta-caryophyllene can be present in a gin-like alcoholic beverage in an amount of, for example, about 0.00006 wt % to about 0.00012 wt % (e.g., about 0.00006 to about 0.00007 wt %, about 0.00007 to about 0.00008 wt %, about 0.00008 to about 0.00009 wt %, about 0.00009 to about 0.0001 wt %, about 0.0001 to about 0.00011 wt %, or about 0.00011 to about 0.00012 wt %). In some cases, about 0.00012 wt % to about 12 wt % (e.g., about 0.00012 wt % to about 0.0012 wt %, about 0.0012 wt % to about 0.012 wt %, about 0.012 wt % to about 0.12 wt %, about 0.12 wt % to about 1.2 wt %, about 1.2 wt % to about 2.0 wt %, about 2.0 wt % to about 4.0 wt %, about 4.0 wt % to about 6.0 wt %, about 6.0 wt % to about 8.0 wt %, about 8.0 wt % to about 10.0 wt %, about 10.0 wt % to about 12.0 wt %) of the one or more additional VOCs can be beta-caryophyllene. In some cases, the one or more additional VOCs can include no beta-caryophyllene.

In some cases, the one or more additional VOCs in a gin-like alcoholic beverage can include beta-humulene. The beta-humulene can be present in an amount of, for example, about 0.008 to about 1.5 mg/L (e.g. about 0.008 to about 0.08 mg/L, about 0.08 to about 0.8 mg/mL, about 0.8 to about 1.0 mg/mL, about 1.0 to about 1.3 mg/mL, or about 1.3 to about 1.5 mg/mL). In some cases, about 0.007 wt % to about 11 wt % (e.g. about 0.007 wt % to about 11 wt %, about 0.007 wt % to about 0.07 wt %, about 0.07 wt % to about 0.7 wt %, about 0.7 wt % to about 1.0 wt %, about 1.0 wt % to about 1.5 wt %, about 1.5 wt % to about 2.0 wt %, about 2.0 wt % to about 2.5 wt %, about 2.5 wt % to about 3.0 wt %, about 3.0 wt % to about 3.5 wt %, about 3.5 wt % to about 4.0 wt %, about 4.0 wt % to about 4.5 wt %, about 4.5 wt % to about 5.0 wt %, about 5.0 wt % to about 5.5 wt %, about 5.5 wt % to about 6.0 wt %, about 6.0 wt % to about 6.5 wt %, about 6.5 wt % to about 7.0 wt %, about 7.5 wt % to about 7.0 wt %, about 7.0 wt % to about 7.5 wt %, about 7.5 wt % to about 8.0 wt %, about 8.0 wt % to about 8.5 wt %, about 8.5 wt % to about 9.0 wt %, about 9.0 wt % to about 9.5 wt %, about 9.5 wt % to about 10.0 wt %, about 10.0 wt % to about 10.5 wt %, or about 10.5 wt % to about 11.0 wt %) of the one or more additional VOCs can be beta-humulene. In some cases, the one or more additional VOCs can include no beta-humulene.

In some cases, the one or more additional VOCs in a gin-like alcoholic beverage can include terpinolene. The terpinolene can be present in an amount of, for example, about 0.0006 to about 1.1 mg/L (e.g. about 0.0006 to about 0.006 mg/L, 0.006 to about 0.06 mg/mL, about 0.06 to about 0.6 mg/mL, or about 0.6 to about 1.1 mg/mL). In some cases, about 0.02 wt % to about 9.0 wt % (e.g. about 0.02 wt % to about 0.2 wt %, about 0.2 wt % to about 0.5 wt %, about 0.5 wt % to about 1.0 wt %, about 1.0 wt % to about 1.5 wt %, about 1.5 wt % to about 2.0 wt %, about 2.0 wt % to about 2.5 wt %, about 2.5 wt % to about 3.0 wt %, about 3.0 wt % to about 3.5 wt %, about 3.5 wt % to about 4.0 wt %, about 4.0 wt % to about 4.5 wt %, about 4.5 wt % to about 5.0 wt %, about 5.0 wt % to about 5.5 wt %, about 5.5 wt % to about 6.0 wt %, about 6.0 wt % to about 6.5 wt %, about 6.5 wt % to about 7.0 wt %, about 7.5 wt % to about 7.0 wt %, about 7.0 wt % to about 7.5 wt %, about 7.5 wt % to about 8.0 wt %, about 8.0 wt % to about 8.5 wt %, or about 8.5 wt % to about 9.0 wt %) of the one or more additional VOCs can be terpinolene. In some cases, the one or more additional VOCs can include no terpinolene.

In some cases, the one or more additional VOCs in a gin-like alcoholic beverage can include hexyl acetate. The hexyl acetate can be present in an amount of, for example, about 0.01 to about 0.03 mg/L (e.g. about 0.01 to about 0.015 mg/L, about 0.015 to about 0.02 mg/mL, about 0.02 to about 0.025 mg/mL, or about 0.025 to about 0.03 mg/mL). In some cases, about 10 wt % to about 19 wt % (e.g. about 10 wt % to about 11 wt %, about 11 wt % to about 12 wt %, about 12 wt % to about 13 wt %, about 13 wt % to about 14 wt %, about 14 wt % to about 15 wt %, about 15 wt % to about 16 wt %, about 16 wt % to about 17 wt %, about 17 wt % to about 18 wt %, or about 18 wt % to about 19 wt %) of the one or more additional VOCs can be hexyl acetate. In some cases, the one or more additional VOCs can include no hexyl acetate.

In some cases, the one or more additional VOCs in a gin-like alcoholic beverage can include nonanal. The nonanal can be present in an amount of, for example, about 0.008 to about 0.2 mg/L (e.g. about 0.008 to about 0.08 mg/L, or about 0.08 to about 0.2 mg/mL). In some cases, about 0.006 wt % to about 83 wt % (e.g. about 0.006 wt % to about 0.06 wt %, about 0.06 wt % to about 0.6 wt %, about 0.6 wt % to about 1 wt %, about 1 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50% to about 55%, about 55% to about 60%, about 60% to about 65%, about 65% to about 70%, about 75% to about 80%, or about 80% to about 83%) of the one or more additional VOCs can be nonanal. In some cases, at least about 0.03 wt % (e.g., at least about 0.3 wt %, at least about 3 wt %, at least about 10 wt %, at least about 30 wt %, at least about 50 wt %) of the one or more additional VOCs can be nonanal. In some cases, the one or more additional VOCs can include no nonanal.

In some cases, the one or more additional VOCs in a gin-like alcoholic beverage can include ethyl octanoate. The ethyl octanoate can be present in an amount of, for example, about 0.001 to about 0.06 mg/L (e.g. about 0.001 to about 0.01 mg/L, about 0.01 to about 0.02 mg/L, about 0.02 to about 0.03 mg/L, about 0.03 to about 0.04 mg/L, about 0.04 to about 0.05 mg/L, or about 0.05 to about 0.06 mg/L). In some cases, about 0.0009 wt % to about 0.6 wt % (e.g. about 0.0009 wt % to about 0.009 wt %, about 0.009 wt % to about 0.09 wt %, about 0.09 wt % to about 0.6 wt %) of the one or more additional VOCs can be ethyl octanoate. In some cases, the one or more additional VOCs can include no ethyl octanoate.

In some cases, the one or more additional VOCs in a gin-like alcoholic beverage can include ethyl hexanoate. The ethyl hexanoate can be present in an amount of, for example, about 0.001 to about 0.7 mg/L (e.g. about 0.001 to about 0.01 mg/L, about 0.01 to about 0.1 mg/L, about 0.1 to about 0.2 mg/L, about 0.2 to about 0.3 mg/L, about 0.3 to about 0.4 mg/L, about 0.4 to about 0.5 mg/L, about 0.5 to about 0.6 mg/L, or about 0.6 to about 0.7 mg/L). In some cases, about 0.001 wt % to about 6 wt % (e.g. about 0.001 wt % to about 0.01 wt %, about 0.01 wt % to about 0.1 wt %, about 0.1 wt % to about 1.0 wt %, about 1.0 wt % to about 1.5 wt %, about 1.0 wt % to about 1.5 wt %, about 1.5 wt % to about 2.0 wt %, about 2.0 wt % to about 2.5 wt %, about 2.5 wt % to about 3.0 wt %, about 3.0 wt % to about 3.5 wt %, about 3.5 wt % to about 4.0 wt %, about 4.0 wt % to about 4.5 wt %, about 4.5 wt % to about 5.0 wt %, about 5.0 wt % to about 5.5 wt %, or about 5.5 wt % to about 6.0 wt %) of the one or more additional VOCs can be ethyl hexanoate. In some cases, the one or more additional VOCs can include no ethyl hexanoate.

In some cases, the one or more additional VOCs in a gin-like alcoholic beverage can include isobutyl angelate. The isobutyl angelate can be present in an amount of, for example, about 0.001 to about 1 mg/L (e.g. about 0.001 to about 0.01 mg/L, about 0.01 to about 0.1 mg/L, or about 0.1 to about 1 mg/L). In some cases, about 0.0008 wt % to about 8 wt % (e.g. about 0.0008 wt % to about 0.008 wt %, about 0.008 wt % to about 0.08 wt %, about 0.08 wt % to about 0.8 wt %, about 0.8 wt % to about 1.5 wt %, about 1.5 wt % to about 2.5 wt %, about 2.5 wt % to about 3.5 wt %, about 3.5 wt % to about 4.5 wt %, about 4.5 wt % to about 5.5 wt %, about 5.5 wt % to about 6.5 wt %, about 6.5 wt % to about 7.5 wt %, or about 7.5 wt % to about 8 wt %) of the one or more additional VOCs can be isobutyl angelate. In some cases, the one or more additional VOCs can include no isobutyl angelate.

In some cases, the one or more additional VOCs in a gin-like alcoholic beverage can include naphthalene. The naphthalene can be present in an amount of, for example, about 0.0007 to about 0.005 mg/L (e.g. about 0.0007 to about 0.0009 mg/L, about 0.0009 to about 0.002, or about 0.002 to about 0.005 mg/L). In some cases, about 0.0005 wt % to about 0.04 wt % (e.g. about 0.0005 wt % to about 0.005 wt %, or about 0.005 wt % to about 0.04 wt %) of the one or more additional VOCs can be naphthalene. In some cases, the one or more additional VOCs can include no naphthalene.

In some cases, the one or more additional VOCs in a gin-like alcoholic beverage can include L-bornyl acetate. The L-bornyl acetate can be present in an amount of, for example, about 0.02 to about 0.4 mg/L (e.g. about 0.02 to about 0.05 mg/L, about 0.05 to about 0.1 mg/L, about 0.1 to about 0.15 mg/L, about 0.15 to about 0.2 mg/L, about 0.2 to about 0.25 mg/L, about 0.25 to about 0.3 mg/L, about 0.3 to about 0.35 mg/L, or about 0.35 to about 0.4 mg/L). In some cases, about 0.01 wt % to about 3.8 wt % (e.g. about 0.01 wt % to about 0.1 wt %, about 0.01 wt % to about 0.1 wt %, about 0.1 wt % to about 1.0 wt %, about 1.0 wt % to about 1.5 wt %, about 1.5 wt % to about 2.0 wt %, about 2.0 wt % to about 2.5 wt %, about 2.5 wt % to about 3.0 wt %, about 3.0 wt % to about 3.5 wt %, or about 3.5 wt % to about 3.8 wt %) of the one or more additional VOCs can be L-bornyl acetate. In some cases, the one or more additional VOCs can include no L-bornyl acetate.

In some cases, the one or more additional VOCs in a gin-like alcoholic beverage can include a-phellandrene. The a-phellandrene can be present in an amount of, for example, about 6.7 to about 12.5 mg/L (e.g. about 6.7 to about 7.0 mg/L, about 7.0 to about 7.5 mg/L, about 7.5 to about 8.0 mg/L, about 8.0 to about 8.5 mg/L, about 8.5 to about 9.0 mg/L, about 9.0 to about 9.5 mg/L, about 9.5 to about 10.0 mg/L, about 10.0 to about 10.5 mg/L, about 10.5 to about 11.0 mg/L, about 11.0 to about 11.5 mg/L, about 11.5 to about 12.0 mg/L, or about 12.0 to about 12.5 mg/L). In some cases, about 4.9 wt % to about 100 wt % (e.g. about 4.9 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 100 wt %) of the one or more additional VOCs can be a-phellandrene. In some cases, the one or more additional VOCs can include no a-phellandrene.

In some cases, the one or more additional VOCs in a gin-like alcoholic beverage can include dehydrosabinene. The dehydrosabinene can be present in an amount of, for example, about 0.2 to about 5.8 mg/L (e.g. about 0.2 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, about 4.5 to about 5.0 mg/L, about 5.0 to about 5.5 mg/L, or about 5.5 to about 5.8 mg/L). In some cases, about 0.2 wt % to about 37.0 wt % (e.g. about 0.2 wt % to about 2.0 wt %, about 2.0 wt % to about 5.0 wt %, about 5.0 wt % to about 10.0 wt %, about 10.0 wt % to about 15.0 wt %, about 15.0 wt % to about 20.0 wt %, about 20.0 wt % to about 25 wt %, about 25.0 wt % to about 30.0 wt %, about 30.0 wt % to about 35.0 wt %, or about 35.0 wt % to about 37.0 wt %) of the one or more additional VOCs can be dehydrosabinene. In some cases, the one or more additional VOCs can include no dehydrosabinene.

In some cases, the one or more additional VOCs in a gin-like alcoholic beverage can include eucalyptol. The eucalyptol can be present in an amount of, for example, about 0.003 to about 8.5 mg/L (e.g. about 0.003 to about 0.03 mg/L, about 0.03 to about 0.3 mg/L, about 0.3 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, about 4.5 to about 5.0 mg/L, about 5.0 to about 5.5 mg/L, about 5.5 to about 6.0 mg/L, about 6.0 to about 6.5 mg/L, about 6.5 to about 7.0 mg/L, about 7.0 to about 7.5 mg/L, about 7.5 to about 8.0 mg/L, or about 8.0 to about 8.5 mg/L). In some cases, about 0.002 wt % to about 84.0 wt % (e.g. about 0.002 wt % to about 0.02 wt %, about 0.02 wt % to about 0.2 wt %, about 0.2 wt % to about 2.0 wt %, about 2.0 wt % to about 5.0 wt %, about 5.0 wt % to about 10.0 wt %, about 15.0 wt % to about 20.0 wt %, about 20.0 wt % to about 25.0 wt %, about 25.0 wt % to about 30.0 wt %, about 30.0 wt % to about 35.0 wt %, about 35.0 wt % to about 40.0 wt %, about 40.0 wt % to about 45.0 wt %, about 45.0 wt % to about 50.0 wt %, about 50.0 wt % to about 55.0 wt %, about 55.0 wt % to about 60.0 wt %, about 60.0 wt % to about 65.0 wt %, about 65.0 wt % to about 70.0 wt %, about 70.0 wt % to about 75.0 wt %, about 75.0 wt % to about 80.0 wt %, or about 80.0 wt % to about 83.0 wt %) of the one or more additional VOCs can be eucalyptol. In some cases, the one or more additional VOCs can include no eucalyptol.

In some cases, the one or more additional VOCs in a gin-like alcoholic beverage can include alpha-terpinyl acetate. The alpha-terpinyl acetate can be present in an amount of, for example, about 0.03 to about 3.3 mg/L (e.g. about 0.03 to about 0.3 mg/L, about 0.3 to about 1.0 mg/L, about 1.0 to about 1.5 mg/L, about 1.5 to about 2.0 mg/L, about 2.0 to about 2.5 mg/L, about 2.5 to about 3.0 mg/L, or about 3.0 to about 3.3 mg/L). In some cases, about 0.02 wt % to about 24.0 wt % (e.g. about 0.02 wt % to about 0.2 wt %, about 0.2 wt % to about 2.0 wt %, about 2.0 wt % to about 4.0 wt %, about 4.0 wt % to about 6.0 wt %, about 6.0 wt % to about 8.0 wt %, about 8.0 wt % to about 10.0 wt %, about 10.0 wt % to about 12.0 wt %, about 12.0 wt % to about 14.0 wt %, about 14.0 wt % to about 16.0 wt %, about 16.0 wt % to about 18.0 wt %, about 18.0 wt % to about 20.0 wt %, about 20.0 wt % to about 22.0 wt %, or about 22.0 wt % to about 24.0 wt %) of the one or more additional VOCs can be alpha-terpinyl acetate. In some cases, the one or more additional VOCs can include no alpha-terpinyl acetate.

In some cases, the one or more additional VOCs in a gin-like alcoholic beverage can include isoborneol, camphene, 1,3-di-tert-butylbenzene, or any combination thereof.

In some cases, a gin replica can include non-volatile compounds. A non-limiting example of a non-volatile compound that can be included in a gin replica is a coloring agent (e.g., a caramel coloring agent, a Food, Drugs and Cosmetics (FD&C) color, or a naturally-sourced color from a fruit or a vegetable). The non-volatile compound(s) can be present at any suitable amount within a gin replica. In some cases, for example, added non-volatile compound(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a gin replica. In some cases, a gin replica can include no added non-volatile compounds.

In some embodiments, the non-volatile compounds can include one or more non-volatile compounds that are not present in a corresponding traditional gin. It is surprising that the gin replicas described herein include one or more compounds not found in any tested traditional gin, as it would be expected that to create a gin replica, one would only think to use compounds found in one or more traditional gins.

In some embodiments, the non-volatile compounds can exclude one or more non-volatile compounds that are present in a corresponding traditional gin. It is surprising that the gin replicas described herein lack one or more compounds found in every tested traditional gins, as one would believe that compounds present in every tested traditional gin to be important to gin flavor.

The non-volatile compounds present in a gin replica can include compounds that fall into any of several categories, including sugars, sugar alcohols, or a combination thereof; amino acids, amino acid derivatives, or a combination thereof; pH-modifying salts; organic acids; nucleobases, nucleotides, or a combination thereof, nitrogen-containing heterocycles; and phenolic compounds. Additional categories can include lipids, vitamins, other flavorants, colors, tannin components, salt (e.g., NaCl). It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

In some embodiments, the gin replicas provided herein can include one or more (e.g., one, two, three, four, five, six, seven, eight, nine, ten, 15, 20, or more than 20) non-volatile compounds that are not present in a corresponding traditional gin.

Again, non-volatile compounds can be detected in traditional gins using any suitable method, including the LC-MS method described in Example 1 herein. A non-volatile compound that is “not present” in a reference gin is one that is not detected in the reference gin using the methods set forth in Example 3.

A gin replica can include any appropriate number of non-volatile compounds. For example, a gin replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some cases, the number of non-volatile compounds in a gin replica can be less than the number of non-volatile compounds in a single corresponding reference gin.

Further, in some embodiments, the gin replicas provided herein can lack one or more (e.g., one, two, three, four, five, six, seven, eight, nine, ten, or more than ten) non-volatile compounds that are present in corresponding traditional gins. In some cases, the overall population of non-volatile compounds in a gin replica can have less than 95% identity to the non-volatile compounds in a corresponding reference gin (e.g., in a single type of traditionally made gin corresponding to the replica). For example, the non-volatile compounds in a gin replica can have less than 90%, less than 80%, less than 70%, less than 60%, less than 50%, less than 40%, less than 30%, or less than 25% identity to the population of non-volatile compounds in a corresponding reference gin. Some gin replicas may contain at least 1 (e.g., at least 2, at least 5, at least 10, at least 15, at least 20, at least 25, or at least 30) non-volatile compounds that are not found in a single reference gin. Moreover, some gin replicas may contain no more than 50 (e.g., no more than 45, 40, 35, 30, 25, 20, 15, or 10) non-volatile compounds that are present in a single reference gin. For example, in some embodiments, a gin replica can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference gin; in some embodiments, m can be equal to 5, 6, 7, 8, 9, 10, 11, 12, 13, 14, 15, 16, 17, 18, 19, 20, 25, 30, 35, 40, 45, 50, 55, or 60.

As noted above, the amounts of non-volatile compounds in reference gins are measured using the LC-MS methods described herein. In some embodiments, the amount of a particular non-volatile compound in a gin replica can be an amount, based on concentration or percent composition, that is within a range 30% higher and lower than a measured amount for that non-volatile compound in a corresponding reference gin. For example, a non-volatile compound can be present in a gin replica in an amount that is 70 to 90%, 80 to 100%, 90 to 110%, 100 to 120%, 110 to 130%, 70 to 100%, 80 to 110%, 90 to 120%, or 100 to 130% of an amount measured for that non-volatile compound in a corresponding reference gin.

In some cases, the amount of any particular non-volatile compound in a gin replica may be different than the amount of that non-volatile compound in a corresponding reference gin. In some cases, the amount of a non-volatile compound in a gin replica can be 75% or less (e.g., 70% or less, 60% or less, 50% or less, 40% or less, 30% or less, 20% or less, or 10% or less), by concentration or percent mass, than the amount of the same non-volatile compound in a corresponding reference gin. In some cases, the amount of a non-volatile compound in a gin replica can be 125% or more (e.g., 150% or more, 200% or more, or 300% or more), by concentration or percent mass, than the amount of the same non-volatile compound in a corresponding reference gin.

Because of the methods by which they are made, the gin-like alcoholic beverages provided herein can lack contaminants and other detrimental compounds that sometimes are encountered in traditional alcoholic beverages. These include, without limitation, organisms such as Escherichia coli, Salmonella sp., Brettanomyces sp., Lactobacillales, Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, and heavy metals.

It is noted that while gin replicas can include volatile and non-volatile compounds as listed herein, the added compounds may react with one another to generate additional compounds, or to change the effective amount of one or more of the added compounds within the gin replica formulation.

This document also provides methods for making gin replicas. In some cases, the methods provided herein can be carried out by first mixing water with ethanol (e.g., a grain neutral spirit and, optionally, a traditional gin, where the traditional gin (if included) is added in an amount such that it makes up about 10 wt % or less (e.g., about 1 wt % or less) of the gin replica product), glycerin, optionally one or more sugars, and optionally one or more plant oils, fruit oils, plant flavors, or fruit flavors, and adding small quantities of diluted VOCs and, optionally, non-volatile compounds. In general, the water, ethanol, glycerin, sugar (when included), and/or plant or fruit oils or flavors (when included), and added VOCs and non-volatile compounds (when included) are all used to generate a final product having the characteristics of a traditionally-produced gin.

In some cases, a method of making a gin replica provided herein can include providing an aqueous solution and adding to the aqueous solution ingredients including ethanol (e.g., a grain neutral spirit and, optionally, a traditional gin, where the traditional gin (if included) is added in an amount such that it makes up about 10 wt % or less (e.g., about 5 wt % or less, or about 1 wt % or less) of the gin replica product), glycerin (e.g., 1 to 3 wt %, or about 2 wt % glycerin), optionally one or more sugars, optionally one or more plant oils, fruit oils, plant flavors, or fruit flavors, optionally one or more nonvolatile compounds (e.g., coloring agents), and one or more (e.g., one, two, three, four, five, six, seven, eight, nine, ten, 11, 12, 13, 14, 15, 16, 17, 18, 19, 20, 21, 22, 23, 24, 25, three or more, five or more, ten or more, 12 or more, 15 or more or 20 or more) additional VOCs, where the added VOCs include at least one terpene and, optionally, an aldehyde. For example, the added VOCs that are combined with the other ingredients can be selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, cuminaldehyde, citronellol, nerol, geraniol, and beta-caryophyllene. In some cases, the added VOCs that are combined with the other ingredients can be selected from the group consisting of 1,3-di-tert-butylbenzene, alpha-phellandrene, alpha-pinene, alpha-terpinyl acetate, beta-caryophyllene, beta-humulene, beta-myrcene, beta-pinene, camphene, d-camphor, dehydrosabinene, d-limonene, ethyl hexanoate, ethyl octanoate, eucalyptol, gamma-terpinene, hexyl acetate, isoborneol, isobutyl angelate, L-bornyl acetate, linalool, naphthalene, nonanal, p-cymene, and terpinolene. In some cases, the added VOCs that are combined with the other ingredients can be selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene. In some cases, the added VOCs that are combined with the other ingredients can be selected from the group consisting of ethyl hexanoate, gamma-terpinene, beta-humulene, linalool, p-cymene, and beta-pinene. In some cases, the added VOCs that are combined with the other ingredients can be selected from the group consisting of ethyl hexanoate, nonanal, alpha-pinene, d-camphor, d-Limonene, eucalyptol, gamma-terpinene, linalool, p-cymene, beta-pinene, and terpinolene. In some cases, the added VOCs that are combined with the other ingredients can be selected from the group consisting of ethyl hexanoate, nonanal, alpha-pinene, d-camphor, eucalyptol, gamma-terpinene, beta-humulene, L-bornyl acetate, linalool, p-cymene, and beta-pinene. In some cases, the added VOCs that are combined with the other ingredients can be selected from the group consisting of hexyl acetate, ethyl hexanoate, isobutyl angelate, nonanal, d-limonene, gamma-terpinene, linalool, and p-cymene.

This document also provides methods for generating concentrated versions of any gin-like alcoholic beverage, where the concentrated versions include glycerin; optionally a sugar; optionally one or more plant oils, fruit oils, plant flavors, or fruit flavors, or any combination thereof, added VOCs; and non-volatile components (if any) of the final product; and optionally any traditional gin, but without the full bulk of the ethanol and water (and in some cases, without any traditional gin). Such concentrates can be manufactured and then shipped to a second location, where water and ethanol (e.g., grain neutral spirits and, optionally, traditional gin) can be added at the appropriate ABV and volume to create a finished product.

Any suitable concentration of traditional gin (if included), glycerin, optional sugar, optional plant oil, fruit oil, plant flavor, or fruit flavor, and additional VOCs and (if present) non-volatile compounds can be used. For example, a concentrated gin-like alcoholic beverage can include optionally a traditional gin; glycerin; optionally a sugar; optionally one or more plant oils, fruit oils, plant flavors, fruit flavors, or any combination thereof, one or more additional VOCs, and non-volatile components (if any) at concentrations that are at least 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold) greater than their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 5-fold, 8-fold, 10-fold, 15-fold, or 20-fold), respectively, with water and ethanol to yield the final product. The concentrates provided herein can contain all of the formulaic components that are present in the final product. In general, such concentrates can be prepared in much the same way as a non-concentrated gin-like alcoholic beverage, by combining the desired amounts of ingredients but omitting the water and the bulk of the ethanol. It is noted that in some cases, some amount of ethanol can be included in the concentrate in order to facilitate dissolution of the added VOCs and, if any, non-volatile compounds.

### Exemplary Embodiments

Embodiment 1 is a gin replica comprising water; a grain neutral spirit; glycerin; optionally, a sugar; optionally, a plant oil, fruit oil, plant flavor, or fruit flavor; and at least three added volatile compounds (VOCs), wherein said added VOCs comprise one or more terpenes and one or more esters, and wherein said added VOCs comprise about 0.001 wt % to about 0.1 wt % of said alcoholic beverage.

Embodiment 2 is the gin replica of embodiment 1, wherein said one or more terpenes comprise one or more of alpha-pinene, d-camphor, d-limonene, eucalyptol, gamma-terpinene, beta-humulene, L-bornyl acetate, linalool, p-cymene, beta-pinene, and terpinolene.

Embodiment 3 is the gin replica of embodiment 1, wherein said one or more terpenes comprise one or more of gamma-terpinene, beta-humulene, linalool, p-cymene, and beta-pinene.

Embodiment 4 is the gin replica of embodiment 1, wherein said one or more terpenes comprise one or more of alpha-pinene, d-camphor, d-limonene, eucalyptol, gamma-terpinene, linalool, p-cymene, beta-pinene, and terpinolene.

Embodiment 5 is the gin replica of embodiment 1, wherein said one or more terpenes comprise one or more of alpha-pinene, d-camphor, eucalyptol, gamma-terpinene, beta-humulene, L-bornyl acetate, linalool, p-cymene, and beta-pinene.

Embodiment 6 is the gin replica of embodiment 1, wherein said one or more terpenes comprise one or more of d-limonene, gamma-terpinene, linalool, and p-cymene.

Embodiment 7 is the gin replica of any one of embodiments 1 to 6, wherein said one or more esters comprise one or more of hexyl acetate, ethyl hexanoate, and isobutyl angelate.

Embodiment 8 is the gin replica of any one of embodiments 1 to 6, wherein said one or more esters comprise ethyl hexanoate.

Embodiment 9 is the gin replica of any one of embodiments 1 to 8, wherein said added VOCs further comprise one or more aldehydes.

Embodiment 10 is the gin replica of embodiment 9, wherein said one or more aldehydes comprise nonanal.

Embodiment 11 is the gin replica of embodiment 1, wherein said added VOCs comprise three or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

Embodiment 12 is the gin replica of embodiment 1, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

Embodiment 13 is the gin replica of embodiment 1, wherein said added VOCs comprise ethyl hexanoate, gamma-terpinene, beta-humulene, linalool, p-cymene, and beta-pinene.

Embodiment 14 is the gin replica of embodiment 1, wherein said added VOCs comprise ethyl hexanoate, nonanal, alpha-pinene, d-camphor, d-Limonene, eucalyptol, gamma-terpinene, linalool, p-cymene, beta-pinene, and terpinolene.

Embodiment 15 is the gin replica of embodiment 1, wherein said added VOCs comprise ethyl hexanoate, nonanal, alpha-pinene, d-camphor, eucalyptol, gamma-terpinene, beta-humulene, L-bornyl acetate, linalool, p-cymene, and beta-pinene.

Embodiment 16 is the gin replica of embodiment 1, wherein said added VOCs comprise hexyl acetate, ethyl hexanoate, isobutyl angelate, nonanal, d-limonene, gamma-terpinene, linalool, and p-cymene.

Embodiment 17 is the gin replica of any one of embodiments 1 to 16, further comprising a sugar selected from the group consisting of sucrose, fructose, and glucose.

Embodiment 18 is the gin replica of any one of embodiments 1 to 17, further comprising a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil.

Embodiment 19 is the gin replica of any one of embodiments 1 to 18, comprising from about 5 wt % to about 70 wt % water; from about 30 wt % to about 95 wt % grain neutral spirits; from about 0.1 wt % to about 5 wt % glycerin; and from about 0.001 wt % to about 1 wt % added VOCs, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

Embodiment 20 is the gin replica of any one of embodiments 1 to 19, wherein said added VOCs comprise beta-pinene, and wherein said beta-pinene is present in said gin replica at a concentration less than about 0.018 mg/L.

Embodiment 21 is the gin replica of any one of embodiments 1 to 20, wherein said added VOCs comprise terpinolene, and wherein said terpinolene is present in said gin replica at a concentration less than about 0.018 mg/L.

Embodiment 22 is the gin replica of any one of embodiments 1 to 21, wherein said added VOCs comprise d-limonene, and wherein said d-limonene is present in said gin replica at a concentration less than about 0.01 mg/L.

Embodiment 23 is the gin replica of any one of embodiments 1 to 22, wherein said added VOCs comprise gamma-terpinene, and wherein said gamma-terpinene is present in said gin replica at a concentration less than about 0.0056 mg/L.

Embodiment 24 is the gin replica of any one of embodiments 1 to 23, wherein said added VOCs comprise linalool, and wherein said linalool is present in said gin replica at a concentration less than about 0.5 mg/L.

Embodiment 25 is the gin replica of any one of embodiments 1 to 24, wherein said added VOCs comprise d-camphor, and wherein at least about 0.2 wt % of said added VOCs is d-camphor.

Embodiment 26 is the gin replica of any one of embodiments 9 to 25, wherein said added VOCs comprise nonanal, and wherein at least about 0.03 wt % of said added VOCs is nonanal.

Embodiment 27 is the gin replica of any one of embodiments 1 to 26, wherein said gin replica comprises less than about 0.088 wt % of said one or more terpenes.

Embodiment 28 is a method for making a gin replica, wherein said method comprises combining water; a grain neutral spirit; glycerin; optionally, a sugar; optionally, a plant oil, fruit oil, plant flavor, or fruit flavor; and at least three added VOCs, wherein said VOCs are provided as separate ingredients and comprise one or more terpenes and one or more esters, and wherein said added VOCs comprise about 0.001 wt % to about 1 wt % of said gin replica.

Embodiment 29 is the method of embodiment 28, wherein said one or more terpenes comprise one or more of alpha-pinene, d-camphor, d-limonene, eucalyptol, gamma-terpinene, beta-humulene, L-bornyl acetate, linalool, p-cymene, beta-pinene, and terpinolene.

Embodiment 30 is the method of embodiment 28, wherein said one or more terpenes comprise one or more of gamma-terpinene, beta-humulene, linalool, p-cymene, and beta-pinene.

Embodiment 31 is the method of embodiment 28, wherein said one or more terpenes comprise one or more of alpha-pinene, d-camphor, d-limonene, eucalyptol, gamma-terpinene, linalool, p-cymene, beta-pinene, and terpinolene.

Embodiment 32 is the method of embodiment 28, wherein said one or more terpenes comprise one or more of alpha-pinene, d-camphor, eucalyptol, gamma-terpinene, beta-humulene, L-bornyl acetate, linalool, p-cymene, and beta-pinene.

Embodiment 33 is the method of embodiment 28, wherein said one or more terpenes comprise one or more of d-limonene, gamma-terpinene, linalool, and p-cymene.

Embodiment 34 is the method of any one of embodiments 28 to 33, wherein said one or more esters comprise one or more of hexyl acetate, ethyl hexanoate, and isobutyl angelate.

Embodiment 35 is the method of any one of embodiments 28 to 33, wherein said one or more esters comprise ethyl hexanoate.

Embodiment 36 is the method of any one of embodiments 28 to 35, wherein said added VOCs further comprise one or more aldehydes.

Embodiment 37 is the method of embodiment 36, wherein said one or more aldehydes comprise nonanal.

Embodiment 38 is the method of embodiment 28, wherein said added VOCs comprise three or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

Embodiment 39 is the method of embodiment 28, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

Embodiment 40 is the method of embodiment 28, wherein said added VOCs comprise ethyl hexanoate, gamma-terpinene, beta-humulene, linalool, p-cymene, and beta-pinene.

Embodiment 41 is the method of embodiment 28, wherein said added VOCs comprise ethyl hexanoate, nonanal, alpha-pinene, d-camphor, d-Limonene, eucalyptol, gamma-terpinene, linalool, p-cymene, beta-pinene, and terpinolene.

Embodiment 42 is the method of embodiment 28, wherein said added VOCs comprise ethyl hexanoate, nonanal, alpha-pinene, d-camphor, eucalyptol, gamma-terpinene, beta-humulene, L-bornyl acetate, linalool, p-cymene, and beta-pinene.

Embodiment 43 is the method of embodiment 28, wherein said added VOCs comprise hexyl acetate, ethyl hexanoate, isobutyl angelate, nonanal, d-limonene, gamma-terpinene, linalool, and p-cymene.

Embodiment 44 is the method of any one of embodiments 28 to 43, wherein said added VOCs comprise beta-pinene, and wherein said beta-pinene is present in said gin replica at a concentration less than about 0.018 mg/L.

Embodiment 45 is the method of any one of embodiments 28 to 44, wherein said added VOCs comprise terpinolene, and wherein said terpinolene is present in said gin replica at a concentration less than about 0.018 mg/L.

Embodiment 46 is the method of any one of embodiments 28 to 45, wherein said added VOCs comprise d-limonene, and wherein said d-limonene is present in said gin replica at a concentration less than about 0.01 mg/L.

Embodiment 47 is the method of any one of embodiments 28 to 46, wherein said added VOCs comprise gamma-terpinene, and wherein said gamma-terpinene is present in said gin replica at a concentration less than about 0.0056 mg/L.

Embodiment 48 is the method of any one of embodiments 28 to 47, wherein said added VOCs comprise linalool, and wherein said linalool is present in said gin replica at a concentration less than about 0.5 mg/L.

Embodiment 49 is the method of any one of embodiments 28 to 48, wherein said added VOCs comprise d-camphor, and wherein at least about 0.2 wt % of said added VOCs is d-camphor.

Embodiment 50 is the method of any one of embodiments 36 to 49, wherein said added VOCs comprise nonanal, and wherein said at least about 0.03 wt % of said added VOCs is nonanal.

Embodiment 51 is the method of any one of embodiments 28 to 50, wherein said gin replica comprises less than about 0.088 wt % of said one or more terpenes.

Embodiment 52 is the method of any one of embodiments 28 to 51, comprising adding a sugar selected from the group consisting of sucrose, fructose, and glucose.

Embodiment 53 is the method of any one of embodiments 28 to 52, comprising adding a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil.

Embodiment 54 is the method of any one of embodiments 28 to 53, wherein said gin replica comprises from about 5 wt % to about 70 wt % water; from about 30 wt % to about 95 wt % grain neutral spirits; from about 0.1 wt % to about 5 wt % glycerin; and from about 0.001 wt % to about 1 wt % added VOCs, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

Embodiment 55 is a gin replica produced by the method of any one of embodiments 28 to 54.

Embodiment 56 is a gin-like alcoholic beverage concentrate comprising glycerin; optionally, a sugar; optionally, a plant oil, fruit oil, plant flavor, or fruit flavor; and at least three added VOCs, wherein said added VOCs comprise at least one terpene and at least one ester, and wherein at least one of said added VOCs is present in a concentration of at least about 2-fold the concentration of the same VOC in a corresponding traditional gin or a corresponding non-concentrate gin.

Embodiment 57 is the gin-like alcoholic beverage concentrate of embodiment 56, wherein at least one of said added VOCs is present in the concentrate in a concentration of at least about 5-fold the concentration of the same VOCs in a corresponding traditional gin or a corresponding non-concentrate gin.

Embodiment 58 is the gin-like alcoholic beverage concentrate of embodiment 56, wherein at least one of said added VOCs is present in the concentrate in a concentration of at least about 10-fold the concentration of the same VOCs in a corresponding traditional gin or a corresponding non-concentrate gin.

Embodiment 59 is the gin-like alcoholic beverage concentrate of embodiment 56, wherein at least one of said added VOCs is present in the concentrate in a concentration of at least about 15-fold the concentration of the same VOCs in a corresponding traditional gin or a corresponding non-concentrate gin.

Embodiment 60 is the gin-like alcoholic beverage concentrate of any one of embodiments 56 to 59, wherein upon dilution of said gin-like beverage concentrate to a gin-like alcoholic beverage, the gin-like alcoholic beverage is the gin replica of any one of embodiments 1 to 27.

Embodiment 61 is a method of making a gin-like alcoholic beverage concentrate, the method comprising combining glycerin; optionally, a sugar; optionally, a plant oil, fruit oil, plant flavor, or fruit flavor; and at least three added VOCs, wherein said added VOCs comprise at least one terpene and at least one ester, and wherein at least one of said added VOCs is present in a concentration of at least about 2-fold the concentration of the same VOC in a corresponding traditional gin or a corresponding non-concentrate gin.

Embodiment 62 is the method of embodiment 61, wherein at least one of said added VOCs is present in the concentrate in a concentration of at least about 5-fold the concentration of the same VOCs in a corresponding traditional gin or a corresponding non-concentrate gin.

Embodiment 63 is the method of embodiment 61, wherein at least one of said added VOCs is present in the concentrate in a concentration of at least about 10-fold the concentration of the same VOCs in a corresponding traditional gin or a corresponding non-concentrate gin.

Embodiment 64 is the method of embodiment 61, wherein at least one of said added VOCs is present in the concentrate in a concentration of at least about 15-fold the concentration of the same VOCs in a corresponding traditional gin or a corresponding non-concentrate gin.

Embodiment 65 is the method of any one of embodiments 61 to 64, wherein upon dilution of the gin-like beverage concentrate to a gin-like alcoholic beverage, the gin-like alcoholic beverage is the gin replica of any one of embodiments 1 to 19.

Embodiment 66 is an alcoholic beverage comprising (or consisting essentially of) water; a grain neutral spirit; glycerin; optionally, a sugar; optionally, a plant oil, fruit oil, plant flavor, or fruit flavor; and at least three added VOCs, wherein the added VOCs comprise at least one terpene and at least one aldehyde, and wherein the added VOCs comprise about 0.001 wt % to about 0.1 wt % of the alcoholic beverage.

Embodiment 67 is the alcoholic beverage of embodiment 66, wherein the at least one terpene comprises one or more of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, and beta-caryophyllene.

Embodiment 68 is the alcoholic beverage of embodiment 66 or embodiment 67, wherein the at least one aldehyde is cuminaldehyde.

Embodiment 69 is the alcoholic beverage of any one of embodiments 66 to 68, wherein the added VOCs comprise three or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 70 is the alcoholic beverage of any one of embodiments 66 to 68, wherein the added VOCs comprise five or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 71 is the alcoholic beverage of any one of embodiments 66 to 68, wherein the added VOCs comprise ten or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 72 is the alcoholic beverage of any one of embodiments 66 to 68, wherein the added VOCs comprise 15 or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 73 is the alcoholic beverage of any one of embodiments 66 to 72, comprising a sugar selected from the group consisting of sucrose, fructose, and glucose.

Embodiment 74 is the alcoholic beverage of any one of embodiments 66 to 73, comprising a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil.

Embodiment 75 is the alcoholic beverage of any one of embodiments 66 to 74, comprising from about 5 wt % to about 70 wt % water; from about 30 wt % to about 95 wt % grain neutral spirits; from about 0.1 wt % to about 5 wt % glycerin; and from about 0.001 wt % to about 1 wt % added VOCs, wherein the added VOCs comprise five or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 76 is the alcoholic beverage of embodiment 75, wherein the added VOCs consist of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 77 is a method for making an alcoholic beverage, wherein the method comprises combining water; a grain neutral spirit; glycerin; optionally, a sugar; optionally, a plant oil, fruit oil, plant flavor, or fruit flavor; and at least three added VOCs, wherein the VOCs are provided as separate ingredients and comprise at least one terpene and at least one aldehyde, and wherein the added VOCs comprise about 0.001 wt % to about 1 wt % of the alcoholic beverage.

Embodiment 78 is the method of embodiment 77, wherein the at least one terpene comprises one or more of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, and beta-caryophyllene.

Embodiment 79 is the method of embodiment 77 or embodiment 78, wherein the at least one aldehyde is cuminaldehyde.

Embodiment 80 is the method of any one of embodiments 77 to 79, wherein the added VOCs comprise three or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 81 is the method of any one of embodiments 77 to 79, wherein the added VOCs comprise five or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 82 is the method of any one of embodiments 77 to 79, wherein the added VOCs comprise ten or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 83 is the method of any one of embodiments 77 to 79, wherein the added VOCs comprise 15 or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 84 is the method of any one of embodiments 77 to 83, comprising adding a sugar selected from the group consisting of sucrose, fructose, and glucose.

Embodiment 85 is the method of any one of embodiments 77 to 84, comprising adding a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil.

Embodiment 86 is the method of any one of embodiments 77 to 85, wherein the alcoholic beverage comprises from about 5 wt % to about 70 wt % water; from about 30 wt % to about 95 wt % grain neutral spirits; from about 0.1 wt % to about 5 wt % glycerin; and from about 0.001 wt % to about 1 wt % added VOCs, wherein the added VOCs comprise five or more compounds selected from the group consisting of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 87 is the method of embodiment 86, wherein the added VOCs consist of alpha-pinene, beta-pinene, 3-carene, beta-myrcene, limonene, gamma-terpinene, p-cymene, alpha-terpinolene, citronellal, d-camphor, linalool, 4-carvomenthenol, alpha-terpineol, citronellol, nerol, geraniol, beta-caryophyllene, and cuminaldehyde.

Embodiment 88 is an alcoholic beverage produced by the method of any one of embodiments 77 to 87.

Embodiment 89 is a gin-like alcoholic beverage concentrate comprising glycerin; optionally, a sugar; optionally, a plant oil, fruit oil, plant flavor, or fruit flavor; and at least three added VOCs, wherein the added VOCs comprise at least one terpene and at least one aldehyde, and wherein at least one of the added VOCs is present in a concentration of at least about 2-fold the concentration of the same VOC in a corresponding traditional gin or a corresponding non-concentrate gin.

Embodiment 90 is the gin-like alcoholic beverage concentrate of embodiment 89, wherein at least one of the added VOCs is present in the concentrate in a concentration of at least about 5-fold the concentration of the same VOCs in a corresponding traditional gin or a corresponding non-concentrate gin.

Embodiment 91 is the gin-like alcoholic beverage concentrate of embodiment 89, wherein at least one of the added VOCs is present in the concentrate in a concentration of at least about 10-fold the concentration of the same VOCs in a corresponding traditional gin or a corresponding non-concentrate gin.

Embodiment 92 is the gin-like alcoholic beverage concentrate of embodiment 89, wherein at least one of the added VOCs is present in the concentrate in a concentration of at least about 15-fold the concentration of the same VOCs in a corresponding traditional gin or a corresponding non-concentrate gin.

Embodiment 93 is the gin-like alcoholic beverage concentrate of any one of embodiments 89 to 92, wherein upon dilution of the gin-like beverage concentrate to a gin-like alcoholic beverage, the gin-like alcoholic beverage is the alcoholic beverage of any one of embodiments 66 to 76.

Embodiment 94 is a method of making a gin-like alcoholic beverage concentrate, the method comprising combining glycerin; optionally, a sugar; optionally, a plant oil, fruit oil, plant flavor, or fruit flavor; and at least three added VOCs, wherein the added VOCs comprise at least one terpene and at least one aldehyde, and wherein at least one of the added VOCs is present in a concentration of at least about 2-fold the concentration of the same VOC in a corresponding traditional gin or a corresponding non-concentrate gin.

Embodiment 95 is the method of embodiment 94, wherein at least one of the added VOCs is present in the concentrate in a concentration of at least about 5-fold the concentration of the same VOCs in a corresponding traditional gin or a corresponding non-concentrate gin.

Embodiment 96 is the method of embodiment 94, wherein at least one of the added VOCs is present in the concentrate in a concentration of at least about 10-fold the concentration of the same VOCs in a corresponding traditional gin or a corresponding non-concentrate gin.

Embodiment 97 is the method of embodiment 94, wherein at least one of the added VOCs is present in the concentrate in a concentration of at least about 15-fold the concentration of the same VOCs in a corresponding traditional gin or a corresponding non-concentrate gin.

Embodiment 98 is the method of any one of embodiments 94 to 97, wherein upon dilution of the gin-like beverage concentrate to a gin-like alcoholic beverage, the gin-like alcoholic beverage is the alcoholic beverage of any one of embodiments 66 to 76.

The invention will be further described in the following examples, which do not limit the scope of the invention described in the claims.

### EXAMPLES

### Example 1—Exemplary Flavored Gin-Like Alcoholic Beverage

Gin replicas were prepared using the components listed in TABLE 1A. In some cases, the ingredients included the exemplary VOCs listed in TABLE 1B, TABLE 1C, TABLE 1D, TABLE 1E, or TABLE 1F. The ingredients were added to a mixing tank in no particular order, and were mixed for 15-20 minutes and then held until being placed into the desired containers (e.g., bottles or cans).

The gin replica had a final ABV of 40%, and was comparable to gin crafted by traditional methods in terms of its flavor, aroma, mouthfeel, and overall sensory experience.

It also is to be noted that while gin replicas can include added VOCs and, in some cases, non-volatile compounds, the added compounds may react with one another to generate additional compounds, or to change the effective amount of one or more of the added compounds within the gin replica formulation.

TABLE 1A
Exemplary gin replica formulation

| Ingredient | Exemplary wt % |
|---|---|
| Water | 5-70 |
| Alcohol | 30-95 |
| Glycerin | 0.1-5 |
| Sugar | 0.0-10 |
| Plant/fruit oils and flavors | 0.0-0.5 |
| VOCs | 0.0001-1 |
| Terpenes | 0-0.1 |
| Aldehydes | 0-0.1 |

TABLE 1B
Exemplary VOCs in gin replica

| VOC | Exemplary wt % (in replica) |
|---|---|
| alpha-pinene | 0.000742-0.001378 |
| beta-pinene | 0.001085-0.002015 |
| 3-carene | 0.00035-0.00065 |
| beta-myrcene | 0.000777-0.001443 |
| limonene | 0.00007-0.00013 |
| gamma-terpinene | 0.000203-0.000377 |
| p-cymene | 0.000175-0.000325 |
| alpha-terpinolene | 0.00007-0.00013 |
| citronellal | 0.000028-0.000052 |
| d-camphor | 0.000105-0.000195 |
| linalool | 0.000182-0.000338 |
| 4-carvomenthenol | 0.000056-0.000104 |
| alpha-terpineol | 0.00063-0.00117 |
| cuminaldehyde | 0.00007-0.00013 |
| citronellol | 0.000294-0.000546 |
| nerol | 0.000007-0.000013 |
| geraniol | 0.000042-0.000078 |
| beta-caryophyllene | 0.000063-0.000117 |

TABLE 1C
Exemplary VOCs in gin replica

| VOC | Exemplary wt % (in replica) |
|---|---|
| ethyl hexanoate | 0.000000232-0.000000929 |
| gamma-terpinene | 0.0000000742-0.000000297 |
| beta-humulene | 0.000000592-0.00000237 |
| linalool | 0.0000218-0.0000873 |
| p-cymene | 0.00000241-0.000009636 |
| beta-pinene | 0.000000181-0.000000722 |

TABLE 1D
Exemplary VOCs in gin replica

| VOC | Exemplary wt % (in replica) |
|---|---|
| ethyl hexanoate | 0.0000000922-0.000000369 |
| nonanal | 0.0000024-0.00000959 |
| alpha-pinene | 0.00000036-0.00000144 |
| d-camphor | 0.0000131-0.0000523 |
| d-limonene | 0.000000512-0.00000205 |
| eucalyptol | 0.000045-0.000180 |
| gamma-terpinene | 0.000000257-0.00000103 |
| linalool | 0.00000118-0.00000473 |
| p-cymene | 0.00000871-0.0000249 |
| beta-pinene | 0.000000223-0.000000893 |
| terpinolene | 0.0000000411-0.000000164 |

TABLE 1E
Exemplary VOCs in gin replica

| VOC | Exemplary wt % (in replica) |
|---|---|
| ethyl hexanoate | 0.0000000738-0.000000295 |
| nonanal | 0.00000361-0.0000145 |
| alpha-pinene | 0.00000031-0.00000124 |
| d-camphor | 0.0000267-0.000107 |
| eucalyptol | 0.000080823-0.000323 |
| gamma-terpinene | 0.000000232-0.000000930 |
| beta-humulene | 0.000000544-0.00000218 |
| L-bornyl acetate | 0.00000191-0.00000763 |
| linalool | 0.0000049-0.0000196 |
| p-cymene | 0.00000585-0.0000234 |
| beta-pinene | 0.000000388-0.00000155 |

TABLE 1F
Exemplary VOCs in gin replica

| VOC | Exemplary wt % (in replica) |
|---|---|
| hexyl acetate | 0.00000128-0.00000514 |
| ethyl hexanoate | 0.000000112-0.000000448 |
| isobutyl angelate | 0.000000188-0.000000752 |
| nonanal | 0.0000056-0.0000224 |
| d-limonene | 0.000000181-0.000000723 |
| gamma-terpinene | 0.000000228-0.000000912 |
| linalool | 0.0000000533-0.000000213 |
| p-cymene | 0.00000117-0.00000462 |

### Example 2—Scaled Up Production and Generation of Concentrated Gin Replicas

It is to be noted that the above process, and similar processes using variations of the ingredient list, are scaled up for commercial production of a gin-like alcoholic beverage. Such scaled up processes (e.g., to generate 1000 L or more) can utilize tanks or vat, for example.

Gin replica concentrates are made in ˜100 L test batches and held for a minimum of 8 weeks, with periodic sampling at 1, 2, 4, 6, and 8 weeks. Density measurements are taken each week, and three replicate bottles of gin replicas are produced by adding 43% ABV neutral grain spirits prior to filtering through a 0.45 PVDF vacuum filter. Samples are then submitted for analytical testing versus a corresponding non-concentrated gin replica, and versus each other, to assess volatile and non-volatile components. Organoleptic comparisons also are conducted. The concentrates are held in HDPE vessels, or in stainless steel at the highest concentration, to ensure that there are no changes in composition due to the storage material.

To find the appropriate volume of concentrate (5×, 10×, or 20×) to add to create a finished product, the following formulas are used:

$$( {C}_{concentrate} ) ( {V}_{concentrate} ) = ( {C}_{final product} ) ( {V}_{final product} )$$

$${V}_{concentrate} = \frac{( 1 ) ( {V}_{final product} )}{( {C}_{concentrate} )}$$

### Where:

C_{final product}=concentration of final product=1 (i.e., 1×)
V_{final product}=desired volume of finished product
C_{concentrate}=concentration of the concentrate (5×, 10×, or 20×)
V_{concentrate}=volume of concentrate to add to create finished product

### Example 3—VOCs and Non-VOCs in Reference Gin Samples

GC-MS/MS and GC-LECO-TOF-MS were used to assess the amounts of various VOCs in traditional gins.

GC-MS/MS Conditions: All analyses were performed using an Agilent 7890B GC interfaced with a 7000D Triple Quadrupole mass spectrometer, and equipped with a PAL RSI 85 autosampler with syringe attachment. The injection volume was 1.0 μL. Liquid injections had a split ratio of 1:20, with a desorption temperature of 250° C. The column was a 30 m×0.25 mm×0.25 Agilent DB-WAX (ultra inert). Helium was used as the carrier gas at a constant flow rate of 1.3 mL/min. The MS ion source temperature and interface temperature were 250° C. The temperature program was as follows: initial temperature 40° C., held for 2 minutes, then increased to 210° C. at a rate of 10° C./min, and held for 5 minutes, for a total run time of 24 minutes.

GC-LECO-TOF-MS Conditions: All analyses were performed using an Agilent 7890B GC interfaced with a 7820 LECO-TOF mass spectrometer and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, PA). HS-SPME autosampler conditions were as follows: pre-incubation time of 5 minutes, incubation temperature of 60° C., extraction time of 15 minutes, and desorption time 5 minutes. Post-desorption fiber conditioning time was 30 minutes. SPME injections had a split ratio of 1:20, with a desorption temperature of 250° C. The columns were a 29.69 m×0.25 mm×0.25 Agilent Rxi-5MS column attached to a 1.09 m×0.25 mm×0.25 Agilent Rxi-17 Sil MS column. Helium was used as the carrier gas at a constant flow rate of 1 mL/min. The MS ion source temperature and interface temperature were 250° C. The temperature program was as follows: initial temperature 40° C., held for 2 minutes, then increased to 90° C. at a rate of 10° C./min and held for 2 min, then increased to 132° C. at a rate of 10° C./min and held for 2 min, then increased to 145° C. at a rate of 10° C./min and held for 2 min, and finally increased to 240° C. at a rate of 10° C./min held for 5 minutes, for a total run time of 33 minutes.

Selection of target compounds and MRM method development: An outline of the general workflow for GC-MS analyses is as follows. Real samples were first analyzed in full scan mode (m/z 15-550) on the GC/MS-LECO to identify potential target compounds. Collected data were analyzed manually using LECO ChromaTOF Software. Multiple Reaction Monitoring (MRM) optimization was performed for commercially available standards. First, full scan experiments were repeated with liquid injection (10 mg/L in either pure MeOH or DCM) to verify retention time and potential precursor ions. Product ion scans were performed using liquid injection and collision energy of 30 V. Optimized MRM transitions and collision energies were selected and are displayed in TABLE 2. A dynamic MRM (dMRM) method was developed for the generation of calibration curves, as described below. Compounds were divided into four methods (TABLE 2) to minimize simultaneous transitions (no greater than 6).

Preparation of calibration curves for GC-MS/MS: All calibration solutions were prepared as 1 mL in either pure MeOH or DCM in 2-mL amber vials. The concentration range was originally 1-1000 μg/L and then varied based on LOD and expected concentration per compound.

Preparation of calibration curves for GC-LECO-TOF-MS: All calibration solutions were prepared as 10 mL of 10% EtOH in milli-Q water in 20-mL amber vials, with 3 g of salt added to enhance volatility. This concentration of EtOH minimized swelling of the SPME fiber to maximize signal despite the dilution factor. The concentration range was 0.1-50 mg/L.

Quantification in real samples for GC-MS/MS: All samples (15 mL initial volume) were extracted with 3×5 mL DCM and the combined extract was dried with anhydrous magnesium sulfate. Then 1 mL of dried extract was transferred to a 2 mL amber auto vial and were analyzed using Agilent Quantitative Analysis (for QQQ). Values reported as not detected (ND) may are considered to be below the limits of detection (LODs) listed in TABLE 2. LODs were approximated based on S/N ratios as generated by the MassHunter software.

Quantification in real samples for GC-LECO-TOF-MS: All samples (reference samples and replica samples) were prepared as 10 mL in 20-mL amber vials with 3 g of salt and were diluted (4×) in milli-Q water to achieve a final concentration of 10% EtOH. Concentrations were later corrected to account for the dilution factor of the sample. All data were collected in triplicate and were analyzed using Chroma-TOF software. Values reported as not detected (ND) are considered to be below the limits of detection (LODs) listed in TABLE 2. LODs were approximated based on S/N ratios as generated by the Chroma-TOF software.

Various reference gin samples were assayed by GC-MS; the levels of VOCs therein are shown in TABLES 3A, 3B, and 3C. In these tables, each column is designated by a numeral that refers to a particular gin.

TABLE 2
GC/MS/MS Method Transitions and Figures of Merit

| Compound Method | | | | Calibration | |
|---|---|---|---|---|---|
| | RT | | Collision | Range | LOD |
| Name | (min) | Transition | Energy | (mg/L) | (mg/L) |
| beta-humulene | 13.333 | 147.0 → 105.0 | 30 | 0.01-1.0 | 0.01 |
| isoborneol | 13.305 | 121.0 → 77.0 | 30 | 0.05-1.0 | 0.05 |
| beta-pinene | 5.465 | 93.0 → 77.0 | 30 | 0.01-1.0 | 0.01 |
| d-camphor | 11.442 | 152.0 → 93.1 | 30 | 0.02-1.0 | 0.02 |
| terpinolene | 6.608 | 121.0 → 91.0 | 30 | 0.01-1.0 | 0.01 |
| d-limonene | 6.897 | 107.0 → 65.0 | 30 | 0.01-1.0 | 0.01 |
| camphene | 4.838 | 121.0 → 77.0 | 30 | 0.001-1.0 | 0.001 |
| alpha-pinene | 4.213 | 93.0 → 51.1 | 30 | 0.001-1.0 | 0.001 |
| gamma-terpinene | 7.662 | 136.0 → 77.0 | 30 | 0.005-1.0 | 0.005 |
| p-cymene | 8.012 | 119.0 → 91.1 | 30 | 0.02-1.0 | 0.02 |
| hexyl acetate | 8.103 | 84.0 → 41.2 | 30 | 0.01-1.0 | 0.01 |
| nonanal | 9.805 | 98.0 → 41.1 | 30 | 0.01-1.0 | 0.01 |
| ethyl octanoate | 10.383 | 88.0 → 43.0 | 30 | 0.001-1.0 | 0.001 |
| ethyl hexanoate | 7.524 | 88.0 → 43.0 | 30 | 0.001-1.0 | 0.001 |
| isobutyl angelate | 8.326 | 100.0 → 39.1 | 30 | 0.001-1.0 | 0.001 |
| naphthalene | 14.141 | 128.0 → 102.0 | 30 | 0.001-1.0 | 0.001 |
| 1,3-di-tert-butylbenzene | 10.264 | 175.0 → 57.0 | 30 | 0.001-1.0 | 0.001 |
| L-bornyl acetate | 12.295 | 154.0 → 69.0 | 30 | 0.01-1.0 | 0.01 |
| beta-caryophyllene | 12.451 | 133.0 → 91.0 | 30 | 0.01-1.0 | 0.01 |
| beta-myrcene | 6.381 | 93.0 → 65.0 | 30 | 0.01-1.0 | 0.01 |
| linalool | 11.781 | 93.0 → 51.0 | 30 | 0.001-1.0 | 0.001 |
| alpha-phellandrene | 6.355 | 93.0 → 77.0 | 30 | 0.001-0.1 | 0.001 |
| dehydrosabinene | 13.13 | 91.0 → 65.0 | 30 | 0.1-1.0 | 0.1 |
| eucalyptol | 7.004 | 154.0 → 69.0 | 30 | 0.005-1.0 | 0.005 |
| terpinyl acetate | 10.706 | 136.0 → 91.0 | 30 | 0.02-1.0 | 0.02 |

TABLE 3A
VOCs in reference gins

| Round 1 assays | | | | | | | |
|---|---|---|---|---|---|---|---|
| (values in mg/L) | 1 | 2 | 3 | 4 | 5 | 6 | 7 |
| beta-humulene | 0.287 | 0.014 | 0.421 | 0.020 | 0.048 | 0.033 | ND |
| isoborneol | ND | ND | ND | ND | ND | ND | ND |
| beta-pinene | ND | ND | ND | ND | ND | ND | ND |
| d-camphor | 0.493 | 0.392 | 0.116 | ND | 0.212 | 0.219 | ND |
| terpinolene | 0.839 | ND | 0.655 | 0.068 | 0.037 | 0.050 | ND |
| d-limonene | 4.157 | 0.020 | 1.390 | 2.287 | 0.949 | 0.330 | 0.065 |
| camphene | ND | ND | ND | ND | ND | ND | ND |
| alpha-pinene | 15.071 | ND | 12.812 | 1.381 | 1.621 | 2.246 | 0.001 |
| gamma-terpinene | 1.524 | ND | 1.090 | 0.105 | 0.216 | 0.120 | 0.011 |
| p-cymene | 7.849 | 0.032 | 4.164 | 0.495 | 0.983 | 1.672 | 0.054 |
| hexyl acetate | ND | ND | ND | ND | ND | ND | ND |
| nonanal | 0.129 | 0.012 | 0.020 | 0.116 | 0.150 | 0.167 | 0.053 |
| ethyl octanoate | 0.007 | 0.003 | 0.002 | ND | ND | 0.003 | 0.034 |
| ethyl hexanoate | 0.009 | 0.025 | 0.012 | ND | ND | 0.002 | 0.515 |
| isobutyl angelate | ND | 0.004 | ND | ND | ND | ND | 0.003 |
| naphthalene | ND | 0.002 | 0.001 | ND | 0.001 | ND | 0.004 |
| 1,3-di-tert-butylbenzene | ND | ND | ND | ND | ND | ND | ND |
| L-bornyl acetate | 0.335 | 0.024 | 0.090 | ND | ND | 0.121 | ND |
| beta-caryophyllene | 0.387 | ND | ND | 0.019 | 0.043 | 0.070 | ND |
| beta-myrcene | 9.899 | ND | ND | 0.964 | 0.736 | 1.321 | 0.031 |
| linalool | 5.664 | 1.660 | ND | 2.253 | 4.315 | 2.677 | 1.026 |
| alpha-phellandrene | ND | ND | ND | ND | ND | ND | ND |
| dehydrosabinene | 0.968 | ND | 4.410 | ND | ND | ND | ND |
| eucalyptol | 6.472 | 0.986 | 0.033 | 0.153 | 0.015 | 0.295 | 0.538 |
| terpinyl acetate | 2.549 | 0.041 | 2.248 | 0.650 | 0.147 | 0.333 | 0.041 |

TABLE 3B
VOCs in reference gins

| Round 1 assays | | | | | | | |
|---|---|---|---|---|---|---|---|
| (values in mg/L) | 8 | 9 | 10 | 11 | 12 | 13 | 14 |
| beta-humulene | 0.021 | 0.021 | ND | 0.318 | 0.275 | ND | 0.059 |
| isoborneol | ND | ND | ND | ND | ND | ND | ND |
| beta-pinene | ND | ND | ND | ND | ND | 0.057 | ND |
| d-camphor | 0.692 | 0.503 | ND | 0.872 | 0.449 | 0.449 | 1.256 |
| terpinolene | 0.108 | 0.062 | 0.285 | 0.297 | 0.311 | ND | 0.199 |
| d-limonene | 1.875 | 0.720 | 0.855 | 20.795 | 6.269 | 0.350 | 5.642 |
| camphene | ND | ND | ND | ND | ND | ND | ND |
| alpha-pinene | 0.922 | 0.654 | 3.959 | 3.411 | 4.464 | 0.078 | 3.043 |
| gamma-terpinene | 0.658 | 0.187 | 1.036 | 1.648 | 1.146 | 0.082 | 0.823 |
| p-cymene | 2.370 | 1.754 | 9.295 | 6.969 | 2.290 | 0.286 | 3.898 |
| hexyl acetate | ND | ND | ND | ND | ND | ND | ND |
| nonanal | 0.037 | 0.138 | 0.029 | 0.169 | 0.116 | 0.093 | 0.039 |
| ethyl octanoate | 0.004 | ND | 0.048 | 0.012 | 0.017 | ND | 0.002 |
| ethyl hexanoate | 0.033 | ND | 0.043 | 0.005 | ND | ND | 0.013 |
| isobutyl angelate | 0.005 | ND | 0.007 | ND | ND | ND | ND |
| naphthalene | 0.003 | ND | 0.003 | 0.001 | ND | ND | 0.001 |
| 1,3-di-tert-butylbenzene | ND | ND | ND | ND | ND | ND | ND |
| L-bornyl acetate | 0.062 | 0.045 | ND | 0.327 | 0.042 | ND | 0.080 |
| beta-caryophyllene | 0.034 | ND | ND | 0.713 | 0.481 | ND | 0.080 |
| beta-myrcene | 0.756 | 0.313 | 1.604 | 4.180 | 2.459 | 0.135 | 1.970 |
| linalool | 25.366 | 10.748 | 0.992 | 32.875 | 12.344 | 10.503 | 44.361 |
| alpha-phellandrene | ND | ND | ND | ND | ND | ND | ND |
| dehydrosabinene | ND | ND | ND | ND | 0.305 | ND | ND |
| eucalyptol | 0.182 | 0.007 | 0.652 | 1.003 | 0.087 | 0.030 | 0.139 |
| terpinyl acetate | ND | ND | 0.655 | 0.151 | 0.067 | 0.190 | 0.997 |

TABLE 3C
VOCs in reference gins

| Round 1 assays | | | | | | | |
|---|---|---|---|---|---|---|---|
| (values in mg/L) | 15 | 16 | 17 | 18 | 19 | 20 | 21 |
| beta-humulene | 0.014 | 1.033 | 0.033 | 0.084 | 0.159 | 0.038 | 0.014 |
| isoborneol | ND | ND | ND | ND | ND | ND | ND |
| beta-pinene | 0.066 | ND | ND | ND | ND | 0.035 | 0.066 |
| d-camphor | 0.479 | 0.774 | 0.431 | 0.691 | 0.830 | 0.409 | 0.479 |
| terpinolene | ND | ND | 0.134 | 0.083 | 0.154 | 0.041 | ND |
| d-limonene | 0.382 | ND | 0.941 | 0.276 | 2.398 | 0.721 | 0.382 |
| camphene | ND | ND | ND | ND | ND | ND | ND |
| alpha-pinene | 0.116 | 20.854 | 1.171 | 2.932 | 3.351 | 1.086 | 0.116 |
| gamma-terpinene | 0.026 | 2.213 | 0.469 | 0.399 | 1.252 | 0.201 | 0.026 |
| p-cymene | 0.587 | 4.598 | 1.566 | 1.474 | 3.022 | 0.776 | 0.587 |
| hexyl acetate | ND | ND | ND | ND | ND | ND | ND |
| nonanal | 0.014 | 0.043 | 0.028 | 0.034 | 0.025 | 0.168 | 0.014 |
| ethyl octanoate | ND | 0.009 | 0.006 | ND | 0.013 | 0.003 | ND |
| ethyl hexanoate | 0.009 | 0.010 | 0.020 | ND | 0.039 | ND | 0.009 |
| isobutyl angelate | ND | ND | 0.001 | ND | 0.726 | ND | ND |
| naphthalene | ND | ND | 0.002 | 0.001 | 0.002 | ND | ND |
| 1,3-di-tert-butylbenzene | ND | ND | ND | ND | ND | ND | ND |
| L-bornyl acetate | ND | 0.099 | 0.029 | 0.077 | 0.051 | ND | ND |
| beta-caryophyllene | ND | 1.121 | 0.040 | 0.148 | 0.157 | 0.030 | ND |
| beta-myrcene | 0.118 | ND | 0.516 | 1.341 | 1.521 | 0.499 | 0.118 |
| linalool | 13.945 | 23.601 | 14.976 | 23.354 | 14.811 | 8.044 | 13.945 |
| alpha-phellandrene | ND | 9.544 | ND | ND | ND | ND | ND |
| dehydrosabinene | ND | 0.896 | 0.337 | ND | ND | ND | ND |
| eucalyptol | 0.006 | 0.041 | 1.047 | 0.004 | 0.070 | 0.051 | 0.006 |
| terpinyl acetate | 0.038 | 1.030 | 0.509 | 0.193 | 0.209 | 0.165 | 0.038 |

ND = not detected or below limit of detection

LC-MS was used to ascertain the existence of various non-volatile compounds in several reference gin samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:
Polarity: positive or negative mode, as indicated for each method
Resolution: 70,000
Scan range: 60-900 m/z for all methods
Isolation window: 1.5 m/z
MS/MS collision energy: 30

Qualitative analysis was done in Compound Discoverer to gather which LC/MS compounds were present in all reference gins.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A gin replica comprising:
water,
a grain neutral spirit,
glycerin,
optionally, a sugar,
optionally, a plant oil, fruit oil, plant flavor, or fruit flavor, and
at least three added volatile compounds (VOCs), wherein said added VOCs comprise one or more terpenes and one or more esters, and wherein said added VOCs comprise about 0.001 wt % to about 0.1 wt % of said alcoholic beverage.

2. The gin replica of claim 1, wherein said one or more terpenes comprise one or more of alpha-pinene, d-camphor, d-limonene, eucalyptol, gamma-terpinene, beta-humulene, L-bornyl acetate, linalool, p-cymene, beta-pinene, and terpinolene.

3. The gin replica of claim 1, wherein said one or more terpenes comprise one or more of gamma-terpinene, beta-humulene, linalool, p-cymene, and beta-pinene.

4. The gin replica of claim 1, wherein said one or more terpenes comprise one or more of alpha-pinene, d-camphor, d-limonene, eucalyptol, gamma-terpinene, linalool, p-cymene, beta-pinene, and terpinolene.

5. The gin replica of claim 1, wherein said one or more terpenes comprise one or more of alpha-pinene, d-camphor, eucalyptol, gamma-terpinene, beta-humulene, L-bornyl acetate, linalool, p-cymene, and beta-pinene.

6. The gin replica of claim 1, wherein said one or more terpenes comprise one or more of d-limonene, gamma-terpinene, linalool, and p-cymene.

7. The gin replica of any one of claims 1 to 6, wherein said one or more esters comprise one or more of hexyl acetate, ethyl hexanoate, and isobutyl angelate.

8. The gin replica of any one of claims 1 to 6, wherein said one or more esters comprise ethyl hexanoate.

9. The gin replica of any one of claims 1 to 8, wherein said added VOCs further comprise one or more aldehydes.

10. The gin replica of claim 9, wherein said one or more aldehydes comprise nonanal.

11. The gin replica of claim 1, wherein said added VOCs comprise three or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

12. The gin replica of claim 1, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

13. The gin replica of claim 1, wherein said added VOCs comprise ethyl hexanoate, gamma-terpinene, beta-humulene, linalool, p-cymene, and beta-pinene.

14. The gin replica of claim 1, wherein said added VOCs comprise ethyl hexanoate, nonanal, alpha-pinene, d-camphor, d-Limonene, eucalyptol, gamma-terpinene, linalool, p-cymene, beta-pinene, and terpinolene.

15. The gin replica of claim 1, wherein said added VOCs comprise ethyl hexanoate, nonanal, alpha-pinene, d-camphor, eucalyptol, gamma-terpinene, beta-humulene, L-bornyl acetate, linalool, p-cymene, and beta-pinene.

16. The gin replica of claim 1, wherein said added VOCs comprise hexyl acetate, ethyl hexanoate, isobutyl angelate, nonanal, d-limonene, gamma-terpinene, linalool, and p-cymene.

17. The gin replica of any one of claims 1 to 16, further comprising a sugar selected from the group consisting of sucrose, fructose, and glucose.

18. The gin replica of any one of claims 1 to 17, further comprising a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil.

19. The gin replica of any one of claims 1 to 18, comprising:
from about 5 wt % to about 70 wt % water,
from about 30 wt % to about 95 wt % grain neutral spirits,
from about 0.1 wt % to about 5 wt % glycerin, and
from about 0.001 wt % to about 1 wt % added VOCs, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

20. The gin replica of any one of claims 1 to 19, wherein said added VOCs comprise beta-pinene, and wherein said beta-pinene is present in said gin replica at a concentration less than about 0.018 mg/L.

21. The gin replica of any one of claims 1 to 20, wherein said added VOCs comprise terpinolene, and wherein said terpinolene is present in said gin replica at a concentration less than about 0.018 mg/L.

22. The gin replica of any one of claims 1 to 21, wherein said added VOCs comprise d-limonene, and wherein said d-limonene is present in said gin replica at a concentration less than about 0.01 mg/L.

23. The gin replica of any one of claims 1 to 22, wherein said added VOCs comprise gamma-terpinene, and wherein said gamma-terpinene is present in said gin replica at a concentration less than about 0.0056 mg/L.

24. The gin replica of any one of claims 1 to 23, wherein said added VOCs comprise linalool, and wherein said linalool is present in said gin replica at a concentration less than about 0.5 mg/L.

25. The gin replica of any one of claims 1 to 24, wherein said added VOCs comprise d-camphor, and wherein at least about 0.2 wt % of said added VOCs is d-camphor.

26. The gin replica of any one of claims 9 to 25, wherein said added VOCs comprise nonanal, and wherein at least about 0.03 wt % of said added VOCs is nonanal.

27. The gin replica of any one of claims 1 to 26, wherein said gin replica comprises less than about 0.088 wt % of said one or more terpenes.

28. A method for making a gin replica, wherein said method comprises combining:
water,
a grain neutral spirit,
glycerin,
optionally, a sugar,
optionally, a plant oil, fruit oil, plant flavor, or fruit flavor, and
at least three added VOCs, wherein said VOCs are provided as separate ingredients and comprise one or more terpenes and one or more esters, and wherein said added VOCs comprise about 0.001 wt % to about 1 wt % of said gin replica.

29. The method of claim 28, wherein said one or more terpenes comprise one or more of alpha-pinene, d-camphor, d-limonene, eucalyptol, gamma-terpinene, beta-humulene, L-bornyl acetate, linalool, p-cymene, beta-pinene, and terpinolene.

30. The method of claim 28, wherein said one or more terpenes comprise one or more of gamma-terpinene, beta-humulene, linalool, p-cymene, and beta-pinene.

31. The method of claim 28, wherein said one or more terpenes comprise one or more of alpha-pinene, d-camphor, d-limonene, eucalyptol, gamma-terpinene, linalool, p-cymene, beta-pinene, and terpinolene.

32. The method of claim 28, wherein said one or more terpenes comprise one or more of alpha-pinene, d-camphor, eucalyptol, gamma-terpinene, beta-humulene, L-bornyl acetate, linalool, p-cymene, and beta-pinene.

33. The method of claim 28, wherein said one or more terpenes comprise one or more of d-limonene, gamma-terpinene, linalool, and p-cymene.

34. The method of any one of claims 28 to 33, wherein said one or more esters comprise one or more of hexyl acetate, ethyl hexanoate, and isobutyl angelate.

35. The method of any one of claims 28 to 33, wherein said one or more esters comprise ethyl hexanoate.

36. The method of any one of claims 28 to 35, wherein said added VOCs further comprise one or more aldehydes.

37. The method of claim 36, wherein said one or more aldehydes comprise nonanal.

38. The method of claim 28, wherein said added VOCs comprise three or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

39. The method of claim 28, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

40. The method of claim 28, wherein said added VOCs comprise ethyl hexanoate, gamma-terpinene, beta-humulene, linalool, p-cymene, and beta-pinene.

41. The method of claim 28, wherein said added VOCs comprise ethyl hexanoate, nonanal, alpha-pinene, d-camphor, d-Limonene, eucalyptol, gamma-terpinene, linalool, p-cymene, beta-pinene, and terpinolene.

42. The method of claim 28, wherein said added VOCs comprise ethyl hexanoate, nonanal, alpha-pinene, d-camphor, eucalyptol, gamma-terpinene, beta-humulene, L-bornyl acetate, linalool, p-cymene, and beta-pinene.

43. The method of claim 28, wherein said added VOCs comprise hexyl acetate, ethyl hexanoate, isobutyl angelate, nonanal, d-limonene, gamma-terpinene, linalool, and p-cymene.

44. The method of any one of claims 28 to 43, wherein the gin replica comprises the sugar, and wherein the sugar is selected from the group consisting of sucrose, fructose, and glucose.

45. The method of any one of claims 28 to 44, wherein the gin replica comprises the plant oil, fruit oil, plant flavor, or fruit flavor, and wherein the plant oil, fruit oil, plant flavor, or fruit flavor is selected from the group consisting of chamomile flavor, elderflower flavor, geranium flavor, mandarin flavor, orange flavor, pine flavor, rosemary oil, orange oil, thyme oil, and pine oil.

46. The method of any one of claims 28 to 45, wherein said added VOCs comprise beta-pinene, and wherein said beta-pinene is present in said gin replica at a concentration less than about 0.018 mg/L.

47. The method of any one of claims 28 to 46, wherein said added VOCs comprise terpinolene, and wherein said terpinolene is present in said gin replica at a concentration less than about 0.018 mg/L.

48. The method of any one of claims 28 to 47, wherein said added VOCs comprise d-limonene, and wherein said d-limonene is present in said gin replica at a concentration less than about 0.01 mg/L.

49. The method of any one of claims 28 to 48, wherein said added VOCs comprise gamma-terpinene, and wherein said gamma-terpinene is present in said gin replica at a concentration less than about 0.0056 mg/L.

50. The method of any one of claims 28 to 49, wherein said added VOCs comprise linalool, and wherein said linalool is present in said gin replica at a concentration less than about 0.5 mg/L.

51. The method of any one of claims 28 to 50, wherein said added VOCs comprise d-camphor, and wherein at least about 0.2 wt % of said added VOCs is d-camphor.

52. The method of any one of claims 36 to 51, wherein said added VOCs comprise nonanal, and wherein said at least about 0.03 wt % of said added VOCs is nonanal.

53. The method of any one of claims 28 to 52, wherein said gin replica comprises less than about 0.088 wt % of said one or more terpenes.

54. The method of any one of claims 28 to 53, comprising adding a sugar selected from the group consisting of sucrose, fructose, and glucose.

55. The method of any one of claims 28 to 54, comprising adding a plant oil, fruit oil, plant flavor, or fruit flavor selected from the group consisting of chamomile flavor, elderflower flavor, geranium flavor, mandarin flavor, orange flavor, pine flavor, rosemary oil, orange oil, thyme oil, and pine oil.

56. The method of any one of claims 28 to 55, wherein said gin replica comprises:
from about 5 wt % to about 70 wt % water,
from about 30 wt % to about 95 wt % grain neutral spirits,
from about 0.1 wt % to about 5 wt % glycerin, and
from about 0.001 wt % to about 1 wt % added VOCs, wherein said added VOCs comprise five or more compounds selected from the group consisting of alpha-pinene, beta-humulene, beta-pinene, d-camphor, d-limonene, ethyl hexanoate, eucalyptol, gamma-terpinene, hexyl acetate, isobutyl angelate, L-bornyl acetate, linalool, nonanal, p-cymene, and terpinolene.

57. A gin replica produced by the method of any one of claims 28 to 56.

58. A gin-like alcoholic beverage concentrate comprising:
glycerin,
optionally, a sugar,
optionally, a plant oil, fruit oil, plant flavor, or fruit flavor, and
at least three added VOCs, wherein said added VOCs comprise at least one terpene and at least one ester, and wherein at least one of said added VOCs is present in a concentration of at least about 2-fold the concentration of the same VOC in a corresponding traditional gin or a corresponding non-concentrate gin.

59. The gin-like alcoholic beverage concentrate of claim 58, wherein at least one of said added VOCs is present in the concentrate in a concentration of at least about 5-fold the concentration of the same VOCs in a corresponding traditional gin or a corresponding non-concentrate gin.

60. The gin-like alcoholic beverage concentrate of claim 58, wherein at least one of said added VOCs is present in the concentrate in a concentration of at least about 10-fold the concentration of the same VOCs in a corresponding traditional gin or a corresponding non-concentrate gin.

61. The gin-like alcoholic beverage concentrate of claim 58, wherein at least one of said added VOCs is present in the concentrate in a concentration of at least about 15-fold the concentration of the same VOCs in a corresponding traditional gin or a corresponding non-concentrate gin.

62. The gin-like alcoholic beverage concentrate of any one of claims 58 to 61, wherein upon dilution of said gin-like beverage concentrate to a gin-like alcoholic beverage, the gin-like alcoholic beverage is the alcoholic beverage of any one of claims 1 to 27.

63. A method of making a gin-like alcoholic beverage concentrate, the method comprising combining:
glycerin,
optionally, a sugar,
optionally, a plant oil, fruit oil, plant flavor, or fruit flavor, and
at least three added VOCs, wherein said added VOCs comprise at least one terpene and at least one ester, and wherein at least one of said added VOCs is present in a concentration of at least about 2-fold the concentration of the same VOC in a corresponding traditional gin or a corresponding non-concentrate gin.

64. The method of claim 63, wherein at least one of said added VOCs is present in the concentrate in a concentration of at least about 5-fold the concentration of the same VOCs in a corresponding traditional gin or a corresponding non-concentrate gin.

65. The method of claim 63, wherein at least one of said added VOCs is present in the concentrate in a concentration of at least about 10-fold the concentration of the same VOCs in a corresponding traditional gin or a corresponding non-concentrate gin.

66. The method of claim 63, wherein at least one of said added VOCs is present in the concentrate in a concentration of at least about 15-fold the concentration of the same VOCs in a corresponding traditional gin or a corresponding non-concentrate gin.

67. The method of any one of claims 63 to 66, wherein upon dilution of the gin-like beverage concentrate to a gin-like alcoholic beverage, the gin-like alcoholic beverage is the alcoholic beverage of any one of claims 1 to 19.
